(19) United States
(12) Patent Application Publication
(10) Pub. No.: US 2016/0320993 A1
(43) Pub. Date: Nov. 3, 2016

(54) CONTROL APPARATUS AND STORAGE SYSTEM

(71) Applicant: FUJITSU LIMITED, Kawasaki-shi (JP)

(72) Inventors: Yuusuke OOTA, Hiratsuka (JP); Atsushi ISHII, Yokosuka (JP)

(73) Assignee: FUJITSU LIMITED, Kawasaki-shi (JP)

(21) Appl. No.: 15/081,304

(22) Filed: Mar. 25, 2016

(30) Foreign Application Priority Data
Apr. 30, 2015 (JP) 2015-092519

(51) Int. Cl. G06F 3/06

(52) U.S. Cl. CPC G06F 3/0622; G06F 3/067; G06F 3/0619; G06F 3/0604; G06F 3/0653

(57) ABSTRACT

A control unit performs matching processing by using port numbers of a plurality of first ports of a control device and port numbers of a plurality of connection destination ports of a connection destination device and acquires a first matching processing result. The control unit acquires a second matching processing result from a different control device in a subsystem to which the control device belongs. The different control device obtains the second matching processing result by performing second matching processing by using port numbers of a plurality of second ports of the different control device and the port numbers of the plurality of connection destination ports of the connection destination device. The control unit determines whether the control apparatus and the connefction destination device are correctly connected to each other, based on the first and second matching processing results.

### CROSS-REFERENCE TO RELATED APPLICATION

This application is based upon and claims the benefit of priority of the prior Japanese Patent Application No. 2015-092519, filed on Apr. 30, 2015, the entire contents of which are incorporated herein by reference.

### FIELD

The embodiments discussed herein relate to a control apparatus and a storage system.

### BACKGROUND

Storage systems are currently used for storing data. Such a storage system includes a plurality of storage devices (storages) such as hard disk drives (HDDs) or solid state drives (SSDs) and uses large-capacity storage areas. In addition, such a storage system includes a control device that performs access control for reading and writing data on storage devices. There are cases in which a plurality of storage devices and a plurality of control devices are included to establish a redundant configuration in a storage system. In this way, reliability in data access is improved.

Cables are used for connecting a plurality of devices within a system with each other. These devices include ports, and a connector at an end of a cable is inserted into a corresponding one of the ports. Unless necessary ports of these devices are appropriately connected with each other via cables, malfunctions could be caused in a system operation. Thus, methods for detecting erroneous cable connections have been discussed.

For example, there has been proposed a method in which higher-level devices determine whether connections with a lower-level device are appropriate in a system. This system includes first and second higher-level devices and a lower-level device connected thereto via first and second cables, respectively. More specifically, the lower-level device calculates the exclusive OR of two values acquired from the first and second higher-level devices and transmits the exclusive OR to the higher-level devices. The higher-level devices determine whether at lease one of the first and second cables is appropriately connected on the basis of the received exclusive OR.

There has also been proposed another method in which a cable master determines erroneous connections. More specifically, the cable master outputs a connection destination call number. If any one of the cable slaves determines that the call number matches its own number information, this cable slave transmits a response via its response line. In this method, the cable master knows a correspondence relationship among all the response lines and connection destination numbers. Thus, by comparing a connection destination call number with a response line number corresponding to a transmitted response, the cable master determines an appropriate connection.

See, for example, the following documents:

Japanese Laid-open Patent Publication No. 2006-31260

Japanese Laid-open Patent Publication No. 02-181377

It is possible to configure subsystems by using a plurality of control devices in a storage system. With such a plurality of subsystems, a redundant configuration can be established for data access. In such a redundant configuration, if each of the control devices is connected to a predetermined connection destination device (for example, a device that gives identification information to each subsystem or control device), replacement or extension can be made per subsystem or control device. For example, a new control device is added to the storage system by connecting this control device to the connection destination device via a cable.

However, whehter the control device and the connection destination device are appropriately connected via a cable needs to be detected. For example, according to the above proposed method, the higher-level devices use information about the operation results acquired from the lower-level device and detect erroneous connections, and the lower-level device acquires a value from each of the two higher-level devices. Thus, if any one of the cables between the lower-level device and the two higher-level devices is disconnected, the higher-level device disconnected from the lower-level device cannot determine whether there is an erroneous connection. In addition, in a system to which control devices can be added in the future, for example, connection destination numbers (for example, identification numbers) of control devices to be connected in the future are unknown. Thus, it is difficult to previously register a correspondence relationship among the response line numbers and connection destination numbers in the master side (for example, a connection destination device).

### SUMMARY

According to one aspect, there is provided a control apparatus that is installable in plurality in a storage system and that controls data access to storage. The control apparatus includes: a plurality of first ports connectable to a plurality of connection destination ports of a connection destination apparatus via cables; and a processor configured to perform a procedure including: determining whether the control apparatus and the connection destination apparatus are correctly connected to each other, based on a result of first matching processing performed by using port numbers of the plurality of first ports and port numbers of the plurality of connection destination ports and a result of second matching processing performed by using port numbers of a plurality of second ports and the port numbers of the plurality of connection destination ports, the plurality of second ports being provided in a different control apparatus in a subsystem to which the control apparatus belongs.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a storage system according to a first embodiment;

FIG. 2 illustrates examples of erroneous connections in the storage system according to the first embodiment;

FIG. 3 is a flowchart illustrating an example of connection determination processing according to the first embodiment;

FIG. 4 illustrates an information processing system according to a second embodiment;

FIG. 5 illustrates an example of a storage system according to the second embodiment;

FIG. 6 illustrates examples of connections between SVCs and CEs according to the second embodiment;

FIG. 7 illustrates examples of hardware components of CMs and the SVCs according to the second embodiment;

FIG. 8 illustrates examples of hardware components of a monitoring module according to the second embodiment;

FIG. 9 illustrates an example of an operation server according to the second embodiment;

FIG. 10 illustrates examples of functions of the CMs according to the second embodiment;

FIG. 11 illustrates examples of functions of the SVCs according to the second embodiment;

FIG. 12 illustrates an example of a connection management table according to the second embodiment;

FIG. 13 is a flowchart illustrating an example of processing performed by an SVC according to the second embodiment;

FIGS. 14 and 15 are flowcharts illustrating an example of processing performed by a CM according to the second embodiment;

FIG. 16 is an example of a sequence illustrating processing according to the second embodiment;

FIG. 17 illustrates example 1 of erroneous connection according to the second embodiment;

FIG. 18 illustrates example 1 of erroneous connection determination processing according to the second embodiment;

FIG. 19 illustrates example 2 of erroneous connection according to the second embodiment;

FIG. 20 illustrate example 2 of erroneous connection determination processing according to the second embodiment;

FIG. 21 illustrates example 3 of erroneous connection according to the second embodiment;

FIG. 22 illustrates example 3 of erroneous connection determination processing according to the second embodiment;

FIG. 23 illustrates example 4 of erroneous connection according to the second embodiment;

FIG. 24 illustrates example 4 of erroneous connection determination processing according to the second embodiment;

FIG. 25 illustrates example 5 of erroneous connection according to the second embodiment; and

FIG. 26 illustrates example 5 of erroneous connection determination processing according to the second embodiment.

### DESCRIPTION OF EMBODIMENTS

Hereinafter, embodiments will be described with reference to the accompanying drawings, wherein like reference characters refer to like elements throughout.

### First Embodiment

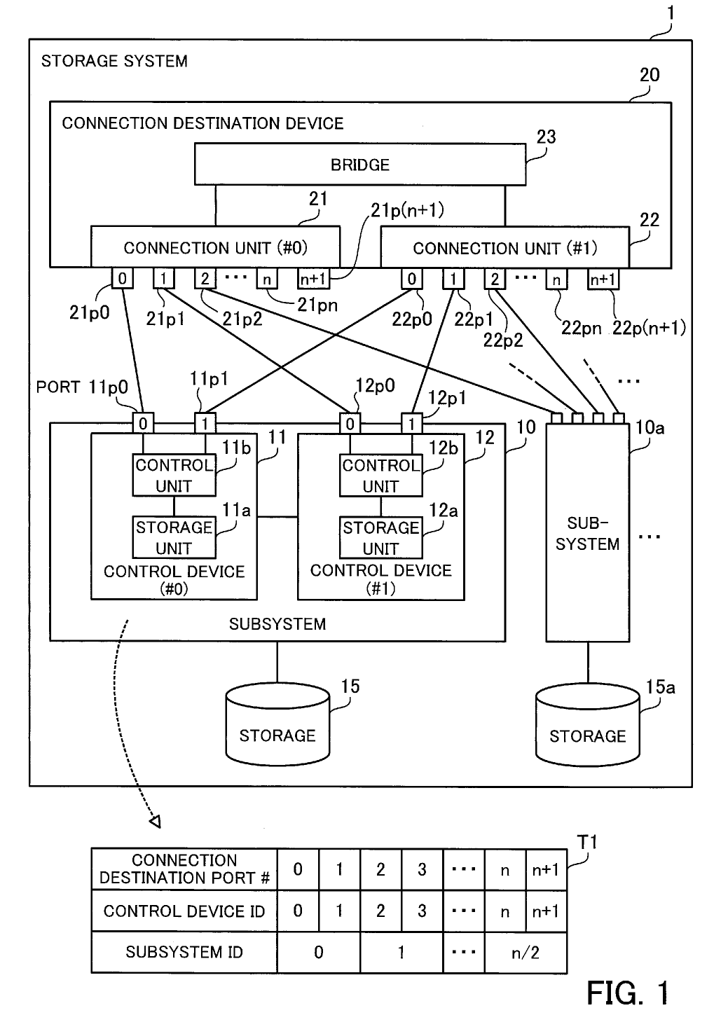

FIG. 1 illustrates a storage system 1 according to a first embodiment. The storage system 1 includes a plurality of storages and provides large-capacity storage areas. The storage system 1 includes subsystems 10 and 10a, storages 15 and 15a, and a connection destination device 20. The subsystem 10 includes control devices 11 and 12 that control data access to the storage 15. The control devices 11 and 12 establish a redundant configuration in the subsystem 10. Namely, the control devices 11 and 12 provide redundant paths to the storage 15. The subsystem 10a also includes two control devices that control data access to the storage 15a. The storage system 1 may include three or more subsystems and three or more storages.

The connection destination device 20 is connected to the subsystems 10 and 10a. For example, in the storage system 1, different data may be stored in the storages 15 and 15a. Alternatively, the storage 15a may be used as a mirror disk of the storage 15. In the latter case, for example, if the connection destination device 20 detects a malfunction in the subsystem 10, the connection destination device 20 operates the subsystem 10a in place of the subsystem 10. Other than this switching function, for example, the connection destination device 20 may have functions of controlling the power supply of each of the subsystems 10 and 10a and monitoring the operating status of each of the subsystems 10 and 10a.

For example, in the storage system 1, replacement or extension can be made per control device or subsystem. If a subsystem is added to the storage system 1, an individual control device that belongs to this subsystem is connected to the connection destination device 20. More specifically, a connector at one end of a cable is inserted into a predetermined port of a control device, and a connector at the other end of the cable is inserted into a predetermined port of the connection destination device 20. As a result, the control device and the connection destination device 20 are connected to each other via this cable. To make this connection between the control device and the connection destination device 20 redundant, the control device and the connection destination device 20 may be connected to each other via two or more cables.

Such wiring with cables is often performed manually by a system administrator, a maintenance worker, or the like. For the connection destination device 20 to appropriately manage the subsystems 10 and 10a and the control devices that belong thereto, it is necessary that the control devices and the connection destination device 20 be correctly connected via cables. Thus, each of the control devices has a function of detecting erroneous cable connections with the connection destination device 20. Hereinafter, as needed, the situation where two devices are connected via a cable will simply be expressed as “two devices are connected.”

The control device 11 includes a storage unit 11a, a control unit 11b, and ports 11p0 and 11p1. The storage unit 11a may be a volatile storage device such as a random access memory (RAM) or a non-volatile storage device such as a flash memory. Examples of the control unit 11b include a central processing unit (CPU), a digital signal processor (DSP), an application specific integrated circuit (ASIC), and a field programmable gate array (FPGA). The control unit 11b may be a processor that executes programs. This “processor” may be a group of processors (a multiprocessor). The ports 11p0 and 11p1 are ports (first ports) connectable to a plurality of connection destination ports of the connection destination device 20 via cables. Each of the ports 11p0 and 11p1 is provided with a port number. The port numbers of the ports 11p0 and 11p1 are “0” and “1,” respectively.

The control device 12 includes a storage unit 12a, a control unit 12b, and ports 12p0 and 12p1. The storage unit 12a, the control unit 12b, and the ports 12p0 and 12p1 have the same functions as those of the storage unit 11a, the control unit 11b, and the ports 11p0 and 11p1, respectively. Each of the ports 12p0 and 12p1 is provided with a port number. The port numbers of the ports 12p0 and 12p1 are “0” and “1,” respectively.

Each of the control devices 11 and 12 is provided with a slot number depending on its physical installation location in the subsystem 10. The slot numbers of the control devices 11 and 12 are “0” (denoted as “#0” in FIG. 1) and “1” (denoted as “#1” in FIG. 1), respectively.

The connection destination device 20 includes connection units 21 and 22 and a bridge 23. Each of the connection units 21 and 22 includes ports (connection destination ports) connected to the control devices via cables.

The connection unit 21 includes ports 21p0, 21p1, 21p2, . . . , 21pn, and 21p(n+1) (n is an even number of 2 or more). Each of the ports of the connection unit 21 is provided with a port number. The port numbers of the ports 21p0 and 21p1 are “0” and “1,” respectively. The port numbers of the ports 21p2, 21pn and 21p(n+1) are “2,” “n,” and “n+1,” respectively.

The connection unit 22 includes ports 22p0, 22p1, 22p2, . . . , 22pn, and 22p(n+1). Each of the ports of the connection unit 22 is provided with a port number. The port numbers of the ports 22p0, 22p1, and 22p2 are “0,” “1,” and “2,” respectively. The port numbers of the ports 22pn and 22p(n+1) are “n” and “n+1,” respectively.

Each of the connection units 21 and 22 is provided with a slot number depending on its physical installation location in the connection destination device 20. The slot numbers of the connection units 21 and 22 are “0” (denoted as “#0” in FIG. 1) and “1” (denoted as “#1” in FIG. 1), respectively.

The bridge 23 connects the connection units 21 and 22 to each other. The connection units 21 and 22 establish a redundant configuration by being connected via the bridge 23. For example, the port 11p0 of the control device 11 is connected to the port 21p0 of the connection unit 21 via a cable, and the port 11p1 of the control device 11 is connected to the port 22p0 of the connection unit 22 via another cable. In this way, even if one of the connection units 21 and 22 malfunctions, the connection destination device 20 is able to continue to communicate with the control device 11.

In the storage system 1, the subsystems 10 and 10a and other control devices such as the control devices 11 and 12 are provided with identification information. The control device 11 determines which ports of the connection units 21 and 22 are connected to the ports 11p0 and 11p1 and recognizes its own identification information (Identifier (ID)). For example, the ID of the control device 11 is indicated by a number (identification number). More specifically, the control unit 11b acquires port numbers (connection destination port numbers) of the connection units 21 and 22 connected to the ports 11p0 and 11p1 via cables from the connection units 21 and 22, respectively. The control unit 11b recognizes the ID of the control device 11 in the storage system 1 on the basis of the connection destination port numbers.

FIG. 1 illustrates an example in which all the ports of the control devices 11 and 12 are correctly connected to the connection destination device 20. For example, the port 11p0 is connected to the port 21p0, and the port 11p1 is connected to the port 22p0.

The control unit 11b recognizes the ID of the control device 11 by performing matching processing by using the ports 11p0 and 11p1 of the control device 11 and the connection destination port numbers of the ports 21p0 and 22p0 connected to the ports 11p0 and 11p1. Among the ports of the connection units 21 and 22, the ports 21p0 and 22p0 are connected to the ports 11p0 and 11p1. For example, both of the port numbers (the connection destination port numbers) of the ports 21p0 and 22p0 are “0.” Thus, since the connection destination port number for the control device 11 is “0,” the control unit 11b determines that the identification number of the control device 11 is “0.”

In addition, for example, the port 12p0 is connected to the port 21p1, and the port 21p1 is connected to the port 22p1. Both of the port numbers (the connection destination port numbers) of the ports 21p1 and 22p1 are “1.” Thus, since the connection destination port number for the control device 12 is “1,” the control unit 12b determines that the identification number of the control device 12 is “1.” In this case illustrated in FIG. 1, the connection destination port numbers of the connection units 21 and 22 in the subsystem 10 are “0” and “1,” respectively. Consequently, the control devices 11 and 12 determine the smaller one of the connection destination port numbers, namely “0,” to be the identification number of the subsystem 10 to which the control devices 11 and 12 belong. The plurality of control devices that belong to the subsystem 10a also acquire their own identification information in the same way as the control devices 11 and 12.

In the above example, since each of the connection units 21 and 22 includes n+2 connection destination ports (n is an even number of 2 or more), a total of n+2 control devices can be included in the storage system 1. Namely, if a single subsystem includes two control devices, the number of subsystems is (n/2+1).

A table T1 indicates the IDs of the control devices (control device IDs) and the IDs of the subsystems (subsystem IDs) based on the connection destination port numbers when the connection destination device 20 and the control devices are correctly connected to each other. For example, the control unit 11b stores the ID of the control device 11 and the ID of the subsystem 10 in the storage unit 11a. In addition, the control unit 12b stores the ID of the control device 12 and the ID of the subsystem 10 in the storage unit 12a.

It is important that these identification numbers allocated to the subsystems and control devices match the physical installation locations of the control devices in the storage system 1. For example, the control devices are horizontally or vertically lined on a rack on which the storage system 1 is placed. For example, it is preferable that the IDs of the control devices be recognized sequentially in accordance with the horizontal installation direction of the control devices in the storage system 1 from left to right (or from right to left) such as “0 (the control device 11), 1 (the control device 12), 2 (the control device 13), and so on.” In this way, for example, the connection destination device 20 is allowed to appropriately recognize and manage the redundant configuration by using the control device IDs. If the control device 12 is connected to the ports 21p2 and 22p2, the control unit 12b determines that the identification number of the control device 12 is “2.” In this case, for example, when the connection destination device 20 displays some information about the ports 21p2 and 22p2 (for example, when the connection destination device 20 lights up a plurality of light emitting diodes (LEDs) that correspond to a plurality of ports of the connection units 21 and 22 in order to indicate power-on states or abnormal states), the displayed content (for example, the LED that corresponds to the control device ID “2”) and the installation location of the control device on the rack (for example, the installation location of the control device 12) do not match. As a result, appropriate maintenance and management could not be performed.

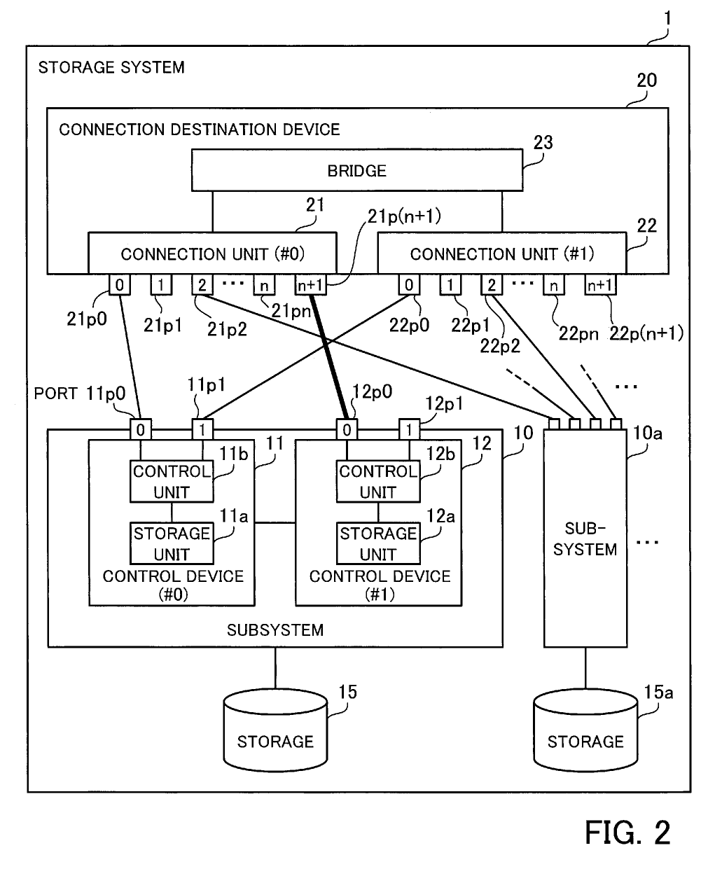

FIG. 2 illustrates examples of erroneous connections in the storage system according to the first embodiment. In the example in FIG. 2, the port 12p0 of the control device 12 is connected to the port 21p(n+1) of the connection unit 21. The port 12p1 of the control device 12 is not connected to any port of the connection units 21 and 22. In this case, the control unit 12b performs the matching processing by using the port numbers and recognizes the port 21p(n+1) whose connection destination port number is “n+1” as the port connected to the port 12p0 whose port number is “0.” Since the control unit 12b cannot acquire any connection destination port number via the port 12p1 whose port number is “1,” the control unit 12b recognizes that the port 12p1 is not connected to the connection destination device 20. Thus, the control device 12 is provided with “n+1” as its ID.

However, as illustrated in FIG. 1, it is appropriate that the control device 12 be provided with “1” as its ID. Namely, because of this erroneous cable connection, the control device 12 has been provided with the erroneous ID “n+1.”

Thus, each of the control units 11b and 12b performs matching processing by using the ports of its own control device and the port numbers of the corresponding connection destination ports, so as to detect whether any cables are erroneously connected. More specifically, each of the control units 11b and 12b is able to perform matching processing by using the port numbers in view of predetermined determination criteria based on connection conditions in the storage system 1. For example, the following matching processing may be performed sequentially. While the following description will be made based on an example in which the control unit 11b performs the matching processing, the control unit 12b and other control devices also perform like matching processing.

In first matching processing, the control unit 11b determines whether the port numbers of the ports 11p0 and 11p1 of the control device 11 match the slot numbers of the connection units 21 and 22 (the numbers indicating the installation locations of the connection units 21 and 22 in the connection destination device 20). If only one of the ports 11p0 and 11p1 of the control device 11 is connected to the connection destination device 20, the control unit 11b performs the first matching processing on the connected port.

In second matching processing, the control unit 11b determines whether both the slot number of the control device 11 in the subsystem 10 (the number indicating the installation location of the control device 11 in the subsystem 10) and the corresponding connection destination port numbers are even numbers or odd numbers.

In third matching processing, the control unit 11b determines whether the same connection destination port number has been acquired via the ports 11p0 and 11p1 of the control device 11. If so, the control unit 11b determines that the connection destination port number of the control device 11 is the connection destination port number acquired via the ports 11p0 and 11p1. If only one of the ports 11p0 and 11p1 of the control device 11 is connected to the connection destination device 20, the control unit 11b determines that the connection destination port number connected to the control device 11 is the connection destination port number acquired via the connected port.

The control unit 11b sequentially performs the first to third matching processing in this order. If the control unit 11b determines that the result of certain matching processing is true, the control unit 11b performs the next matching processing. However, if the control unit 11b determines that the result of certain matching processing is false, the control unit 11b determines that the control device 11 and the connection destination device 20 are erroneously connected.

If all the results of the first to third matching processing are true, it is highly likely that the control device 11 and the connection destination device 20 are correctly connected to each other (however, there is still a possibility of erroneous connection, as will be described below).

For example, the control unit 11b acquires the slot numbers of the connection units 21 and 22 from the respective connection units 21 and 22. The slot numbers of the connection units 21 and 22 are “0” and “1,” respectively. The control unit 11b determines that the port number “0” of the port 11p0 matches the slot number “0” of the connection unit 21 and that the port number “1” of the port 11p1 matches the slot number “1” of connection unit 22. Thus, the control unit 11b determines that the result of the first matching processing is true. Next, the control unit 11b performs the second matching processing.

The control unit 11b acquires the port number “0” of the port 21p0 from the port 21p0, which is the connection destination port of the port 11p0. The control unit 11b acquires the port number “0” of the port 22p0 from the port 22p0, which is the connection destination port of the port 11p1. The control unit 11b compares the port number “0” acquired from the ports 21p0 and 22p0 with the slot number “0” of the control device 11. Since both of the numbers are even numbers and match, the control unit 11b determines that the result of the second matching processing is true. Next, the control unit 11b performs the third matching processing.

The control unit 11b compares the port number “0” of the port 21p0 acquired via the port 11p0 with the port number “0” of the port 22p0 acquired via the port 11p1. Since the same port number has been acquired via the ports 11p0 and 11p1, the control unit 11b determines that the result of the third matching processing is true. Since all the results obtained up to the third matching processing are true, the control unit 11b determines that the connection destination port number of the control device 11 is “0.”

Likewise, the control unit 12b determines that the connection destination port number of the control device 12 is “n+1.” Namely, since the port 12p0 whose port number is “0” is connected to the connection unit 21 whose slot number is “0,” the result of the first matching processing is true. Since the slot number “1” of the control device 12 and the port number “n+1” of the port 21p(n+1) are odd numbers (n is an even number of 2 or more, as described above) and match, the result of the second matching processing is true. Next, the control unit 12b performs the third matching processing and determines the port number “n+1” of the port 21p(n+1) acquired via the port 12p0 to be the connection destination port number of the control device 12.

By performing the first to third matching processing, each of the control devices 11 and 12 is able to determine whether an appropriate connection destination port number has been given. If the port 12p1 of the control device 12 is connected to the port 22p1, the control unit 12b is able to detect that the ports 12p0 and 12p1 are erroneously connected because the third matching processing produces a false result. However, if the port 12p1 is not connected to any port of the connection units 21 and 22 as described above, the control unit 12b cannot determine whether the port 12p0 is erroneously connected by performing the third matching processing. In addition, the above processing does not take into account whether the control devices that belong to the same subsystem are correctly connected. Thus, the control unit 11b additionally performs fourth matching processing (the control unit 12b also performs the fourth matching processing).

In the fourth matching processing, the control unit 11b determines whether a relationship between the connection destination port number determined through the matching processing performed by the control device 11 and the connection destination port number determined through the matching processing performed by the control device 12 that belongs to the subsystem 10 to which the control device 11 also belongs satisfies a connection condition in the storage system 1. In the storage system 1, two control devices that belong to the same subsystem are installed adjacent to each other. Thus, the connection condition for the control devices 11 and 12 that belong to the same subsystem is that the connection destination port numbers of these control devices 11 and 12 are consecutive numbers.

Namely, if the connection destination port numbers are consecutive numbers, the control unit 11b determines that the connection destination port number of the control device 11 is correct with respect to the connection destination port number of the control device 12. Otherwise, the control unit 11b determines that the connection destination port number of the control device is not correct with respect to the connection destination port number of the control device 12. In the case of FIG. 2, the control unit 11b acquires the connection destination port number “n+1” from the control device 12. The control unit 11b compares the connection destination port number “0” determined through the matching processing performed by the control device 11 with the connection destination port number “n+1” determined through the matching processing performed by the control device 12. Since the connection destination port numbers “0” and “n+1” are not consecutive numbers, the control unit 11b determines that the ports 11p0 and 11p1 are erroneously connected to the connection destination device 20. Likewise, the control unit 12b compares the connection destination port number “0” of the control device 11 with the connection destination port number “n+1” of the control device 12 and determines that the port 12p0 is erroneously connected to the connection destination device 20. In this way, whether the subsystem 10 is erroneously connected is appropriately detected.

Next, an example of connection determination processing performed by the control unit 11b will be described. While processing performed by the control unit 11b will be described as an example, the control unit 12b and the control units of the other control devices also perform like processing.

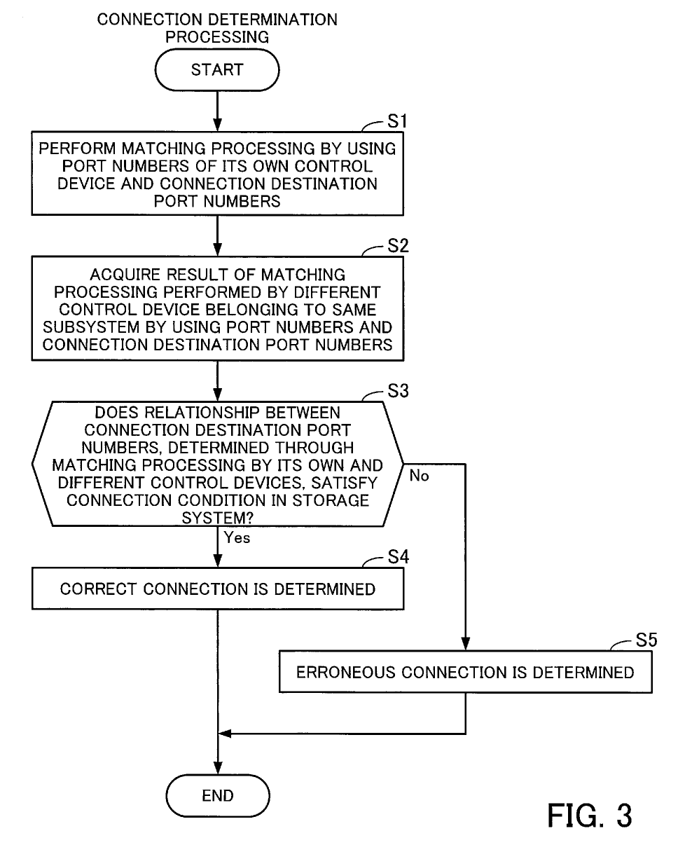

FIG. 3 is a flowchart illustrating an example of connection determination processing according to the first embodiment. Hereinafter, the processing illustrated in FIG. 3 will be described in accordance with step numbers.

(S1) The control unit 11b performs matching processing by using the port numbers of its own control device (the control device 11) and the corresponding connection destination port numbers. The matching processing refers to the first to third matching processing described with reference to FIG. 2. In the case of the connection example in FIG. 2, the control unit 11b determines that the connection destination port number of the control device 11 is “0” as a result of the matching processing.

(S2) The control unit 11b acquires a result of matching processing performed by using port numbers and connection destination port numbers from a different control device (the control device 12) that belongs to the same subsystem 10 to which the control device (control device 11) also belongs. The control unit 12b also performs the matching processing by using its port numbers and the corresponding connection destination port numbers (the above first to third matching processing) in step S1. Thus, the control unit 11b is able to acquire the result of the matching processing performed by the control unit 12b from the control device 12. In the case of the connection example in FIG. 2, the control unit 11b acquires the connection destination port number “n+1” of the control device 12 as the result of the matching processing performed by the control device 12.

(S3) The control unit 11b determines whether the relationship between the connection destination port numbers, determined through the matching processing performed by its own control device (the control device 11) and the different control device (the control device 12), respectively, satisfies the connection condition in the storage system 1. If the relationship satisfies the condition, the processing proceeds to step S4. If not, the processing proceeds to step S5. This determination made in step S3 corresponds to the fourth matching processing described with reference to FIG. 2. The above connection condition in step S3 is that whether the connection destination port numbers determined through the matching processing performed by the control devices 11 and 12, respectively, are consecutive numbers. Namely, if these connection destination port numbers are consecutive numbers, the control unit 11b determines that the connection condition is satisfied. Otherwise, the control unit 11b determines that the connection condition is not satisfied. In the case of the connection example in FIG. 2, the connection destination port numbers “0” and “n+1” of the control device 11 and 12, respectively, are not consecutive numbers. Thus, in this case, the control unit 11b determines that the connection condition is not satisfied.

(S4) The control unit 11b determines that its own control device (the control device 11) and the connection destination device 20 are correctly connected. The control unit 11b may notify the connection destination device 20 that the control device 11 and the connection destination device 20 are accurately connected. Next, the control unit 11b ends the present processing.

(S5) The control unit 11b determines that its own control device (the control device 11) and the connection destination device 20 are erroneously connected. The control unit 11b may notify the connection destination device 20 that the control device 11 and the connection destination device 20 are erroneously connected. Next, the control unit 11b ends the present processing.

In this way, the control device 11 determines whether its connection destination port number is correct in view of the connection destination port number of the control device 12 obtained through the matching processing performed by the control device 12. Thus, whether the control devices 11 and 12 and the connection destination device 20 are accurately connected is appropriately detected. For example, even when the control unit 12b determines that the port 12p1 is not connected and the connection destination port number of the control device 12 is “n+1” as in FIG. 2, by comparing “n+1” with the connection destination port number “0” of the control device 11, the control unit 12b is able to appropriately detect that the port 12p0 is erroneously connected.

As described in steps S4 and S5, the control unit 11b may notify the connection destination device 20 of the connection determination result. For example, the connection destination device 20 instructs the storage system 1 to continuously operate without using this subsystem in which the erroneous connections have been detected (the storage system 1 is caused to perform a degradation operation).

More specifically, in the example in FIG. 2, the control unit 11b notifies the connection destination device 20 that the ports 21p0 and 22p0 which are included in the connection units 21 and 22 and whose port number is “0” are erroneously connected. In addition, the control unit 12b notifies the connection destination device 20 that the port 21p(n+1) which is included in the connection unit 21 and whose port number is “n+1” is erroneously connected. In response, the connection destination device 20 instructs the subsystem 10 not to perform data access by using the control devices 11 and 12 connected to the ports 21p0, 21p(n+1), and 22p0.

For example, when the storage system 1 is activated, the control devices 11 and 12 may perform the above connection determination processing. In this case, the connection destination device 20 stops activating the control devices 11 and 12 while continuing to activate other subsystems. Namely, the storage system 1 is activated without using the subsystem 10. As described above, by preventing the erroneously connected control devices 11 and 12 from being used, the reliability of the operation of the storage system 1 is improved. For example, the connection destination device 20 may notify a user of these erroneously connected ports by lighting up notification LEDs corresponding to the ports 21p0, 21p(n+1), and 22p0 in a predetermined color or by transmitting an error message to a terminal of the user. In this way, the connection destination device 20 may assist the user in finding erroneous connections.

### Second Embodiment

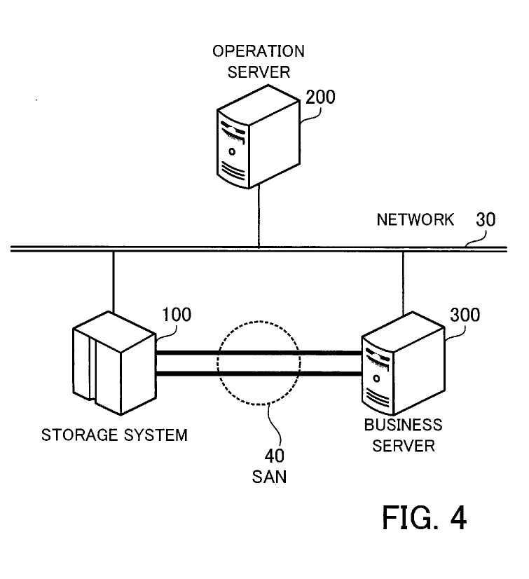

FIG. 4 illustrates an information processing system according to a second embodiment. The information processing system according to the second embodiment includes a storage system 100, an operation server 200, and a business server 300 that are connected to a network 30 such as a local area network (LAN). The storage system 100 and the business server 300 are connected to a storage area network (SAN) 40.

The storage system 100 includes a plurality of storages such as HDDs or SSDs and provides large capacity storage areas. The storage system 100 includes a plurality of subsystems that perform data access to storages, and the reliability in data storage and data access is improved by these subsystems.

The operation server 200 is a server computer that operates and manages the storage system 100 and the business server 300. For example, the operation server 200 provides the storage system 100 with a firmware program executed by the storage system 100.

The business server 300 is a server computer that accesses data stored in the storage system 100 via the SAN 40 and that performs business processing by using the accessed data. The business server 300 may perform business processing in response to requests from a client computer (not illustrated in FIG. 4) connected to the network 30.

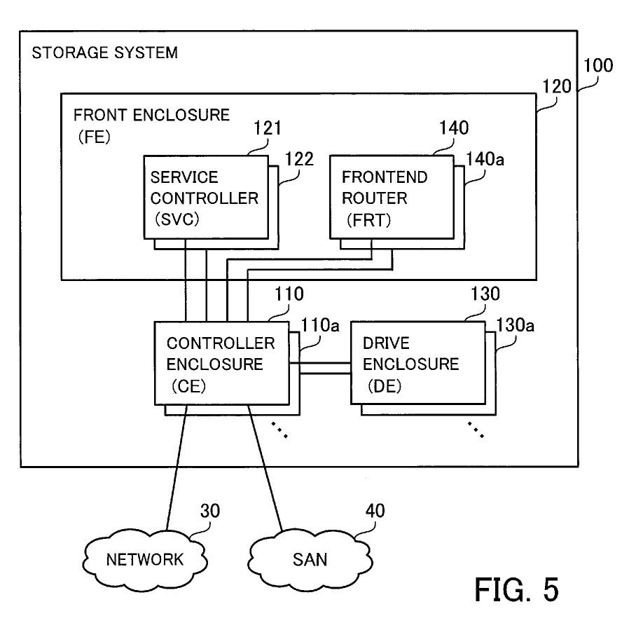

FIG. 5 illustrates an example of the storage system 100 according to the second embodiment. The storage system 100 includes controller enclosures (CEs) 110 and 110a, a front enclosures (FE) 120, and drive enclosures (DEs) 130 and 130a. The storage system 100 may include three or more CEs or three or more DEs.

The CEs 110 and 110a manage the storage areas of the DEs 130 and 130a and control access to the DEs 130 and 130a, respectively. The CEs 110 and 110a are connected to the FE 120 via cables. The CEs 110 and 110a are also connected to the DEs 130 and 130a via cables. In addition, the CEs 110 and 120 are connected to the network 30. The CEs 110 and 120 are examples of the subsystems 10 and 10a according to the first embodiment.

The FE 120 provides functions of managing the CEs 110 and 110a and the DEs 130 and 130a and relaying communications between the CEs. The FE 120 is an example of the connection destination device 20 according to the first embodiment. The FE 120 includes service controllers (SVCs) 121 and 122 and frontend routers (FRTs) 140 and 140a.

For example, the SVCs 121 and 122 include functions of controlling power supplies, monitoring statuses, and setting operations of the CEs 110 and 110a and the DEs 130 and 130a. Examples of the power supply control processing performed by the SVCs 121 and 122 include switching on and off of the power supply of each of these components. Examples of the status monitoring processing performed by the SVCs 121 and 122 include monitoring of occurrence of an error in an operation of any one of the CEs 110 and 110a. Examples of the operation setting processing performed by the SVCs 121 and 122 include setting signal intensities in communications among the CEs 110 and 110a and the FRTs 140 and 140a (setting repeaters of the FRTs 140 and 140a). The SVCs 121 and 122 are examples of the connection units 21 and 22 according to the first embodiment. The FRTs 140 and 140a are relay devices that relay communications between the CEs.

The DEs 130 and 130a accommodate a plurality of HDDs (magnetic disk devices) and provide large capacity storage areas by combining a plurality of HDDs. In place of or in addition to the HDDs, the DEs 130 and 130a may include other non-volatile storage media such as SSDs. For example, the CEs 110 and 110a use a technique called redundant array of independent disks (RAID) with a plurality of HDDs (or SSDs) included in the DEs 130 and 130a. Namely, it is possible to form a logical storage area while ensuring access performance and fault tolerance. By using the HDDs or SSDs included in the DEs 130 and 130a, the CEs 110 and 110a are also able to form a plurality of RAID groups holding the same data. In this way, data storage and access reliability are further improved. The DEs 130 and 130a are examples of the storages 15 and 15a according to the first embodiment.

In the storage system 100, even when any one of the CEs 110 and 110a malfunctions, replacement is possible per CE. Addition (scale out) of a CE to the storage system 100 is also possible. When a new CE is added to the storage system 100, a system administrator, a maintenance worker, or the like connects the new CE to the FE 120 by using a cable.

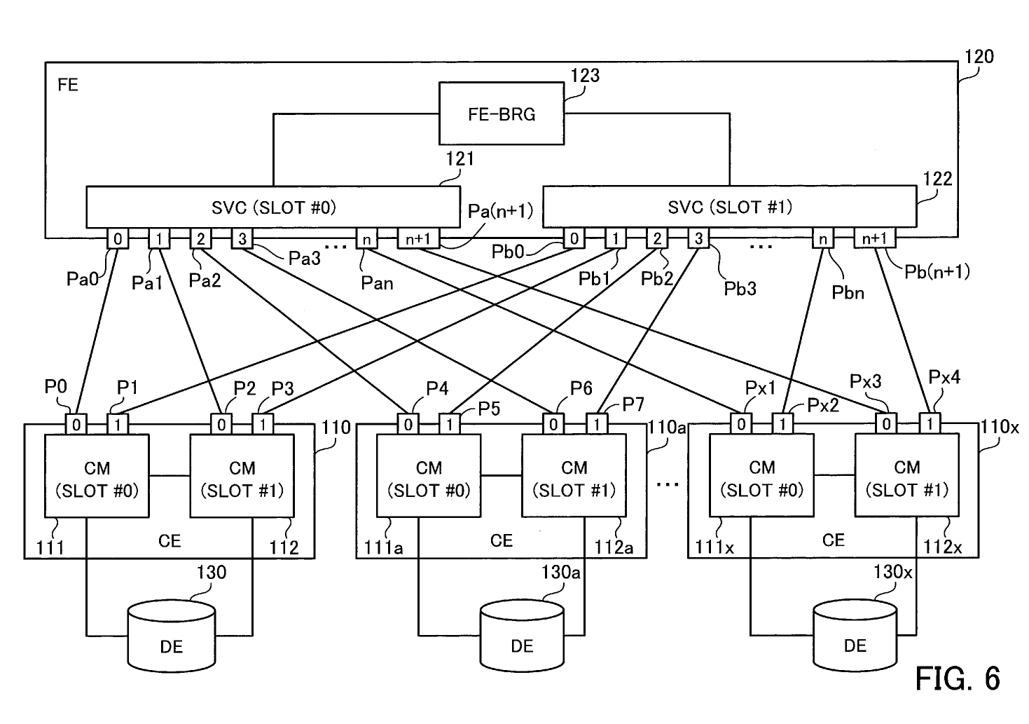

FIG. 6 illustrates examples of connections between SVCs and CEs according to the second embodiment. The CE 110 includes controller modules (CMs) 111 and 112, and the CE 110a includes CMs 111a and 112a. The CMs 111 and 112 control data access to the DE 130, and the CMs 111a and 112a control data access to the DE 130a. The CMs 111, 112, 111a, and 112a are examples of the control devices 11 and 12 according to the first embodiment.

The CMs 111 and 112 are included in two slots in the enclosure of the CE 110, respectively. The slots including the CMs 111 and 112 have slot numbers “0” and “1,” respectively. Likewise, the CMs 111a and 112a are included in two slots of the CE 110a. The slots including the CMs 111a and 112a have slot numbers “0” and “1,” respectively.

Each of the CMs 111, 112, 111a, and 112a has a plurality of ports to be connected to the FE 120 via cables. The CM 111 includes ports P0 and P1 whose port numbers are “0” and “1,” respectively. The CM 112 includes ports P2 and P3 whose port numbers are “0” and “1,” respectively. The CM 111a includes ports P4 and P5 whose port numbers are “0” and “1,” respectively. The CM 112a includes ports P6 and P7 whose port numbers are “0” and “1,” respectively.

The FE 120 includes the SVCs 121 and 122 and a FE-bridge (BRG) 123. As described above, the SVCs 121 and 122 in the FE 120 manage the CEs such as the CEs 110 and 110a. The SVCs 121 and 122 are connected to each other via the FE-BRG 123. The FE-BRG 123 is an example of the bridge 23 according to the first embodiment. The SVCs 121 and 122 are included in two slots of the enclosure of the FE 120, respectively. The slots including the SVCs 121 and 122 have slot numbers “0” and “1,” respectively.

Each of the SVCs 121 and 122 includes a plurality of ports to be connected to the CEs 110 and 110a via cables. The SVC 121 includes port Pa0, Pa1, Pa2, Pa3, . . . , Pan, and Pa(n+1). The ports Pa0, Pa1, and Pa2 have port numbers “0,” “1,” and “2,” respectively. The ports Pa3 and Pan have port numbers “3” and “n,” respectively, and “n” is an even number of two or more. The port Pa(n+1) has a port number “n+1.”

The SVC 122 includes ports Pb0, Pb1, Pb2, Pb3, . . . , Pbn, and Pb(n+1). The ports Pb0, Pb1, and Pb2 have port numbers “0,” “1,” and “2,” respectively. The ports Pb3, Pbn, and Pb(n+1) have port numbers “3,” “n,” and “n+1,” respectively.

The FE-BRG 123 is a bridge that connects the SVCs 121 and 122 to each other. For example, the SVCs 121 and 122 communicate with each other via the FE-BRG 123 and provide redundant paths between the CEs 110 and 110a and the FE 120. For example, recommended standard 422 (RS 422) is used for physical interfaces between the CEs 110 and 110a and the FE 120. Each of the CMs 111, 112, 111a, and 112a is provided with an ID on the basis of the ports of the SVCs 121 and 122 to which it is connected. It is necessary that each of the CMs 111, 112, 111a, and 112a be provided with an appropriate ID on the basis of its installation location in the storage system 100. For example, the CEs 110 and 110a and the FE 120 are correctly connected via cables as follows.

The ports P0 and Pa0 are connected to each other. The ports P1 and Pb0 are connected to each other. The ports P2 and Pa1 are connected to each other. The ports P3 and Pb1 are connected to each other. The ports P4 and Pa2 are connected to each other. The ports P5 and Pb2 are connected to each other. The ports P6 and Pa3 are connected to each other. The ports P7 and Pb3 are connected to each other. If the CMs and the SVC are orderly connected in this way, the FE 120 is connected to a total of n+2 CMs and is able to provide each of the CMs with redundant paths via the SVCs 121 and 122.

While a CE 110x connected to the ports Pan, Pa(n+1), Pbn, and Pb(n+1) is also illustrated in FIG. 6, the CE 110x and a DE 130x are not illustrated in FIG. 5. The CE 110x is the ((n/2)+1)th CE in the storage system 100. For example, the CE 110x controls data access to the DE 130x.

The CE 110x includes CMs 111x and 112x. The CM 111x is the (n+1)th CM in the storage system 100. The CM 112x is the (n+2)th CM in the storage system 100.

The CM 111x includes ports Px1 and Px2 whose port numbers are “0” and “1,” respectively. The CM 112x includes ports Px3 and Px4 whose port numbers are “0” and “1,” respectively. In this case, to correctly connect the CE 110x to the FE 120, the ports Px1, Px2, Px3, and Px4 are connected to the ports Pan, Pbn, Pa(n+1), and Pb(n+1), respectively.

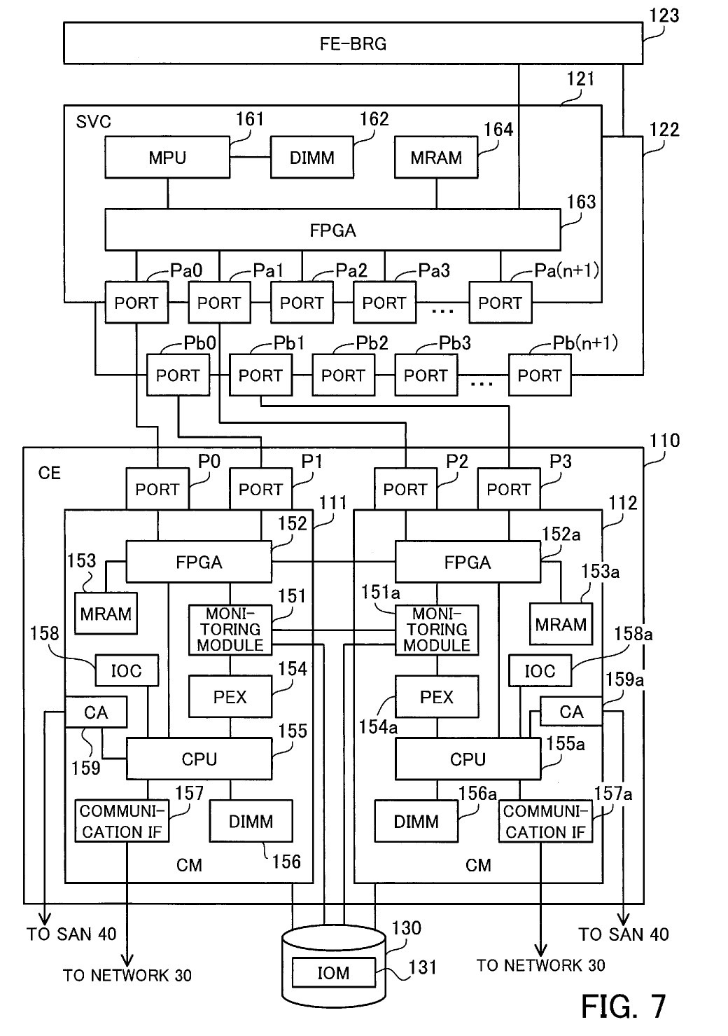

FIG. 7 illustrates examples of hardware components of the CMs and the SVCs according to the second embodiment. The CM 111 includes the ports P0 and P1, a monitoring module 151, an FPGA 152, a magneto-resistive random access memory (MRAM) 153, a peripheral component interconnect (PCI) express (PEX) 154, a CPU 155, a dual inline memory module (DIMM) 156, a communication interface (IF) 157, an input and output controller (IOC) 158, and a channel adaptor (CA) 159.

The ports P0 and P1 are interfaces for connecting the CM 111 to the SVCs 121 and 122, respectively, as described above.

The monitoring module 151 monitors whether the CM 111 and the SVCs 121 and 122 are erroneously connected. The monitoring module 151 is connected to the FPGA 152, the PEX 154, and a monitoring module 151a of the CM 112. Inter-Integrated Circuit (I2C) may be used for the interface between the monitoring modules 151 and 151a, for example. The monitoring module 151 may be what is called “expander.”

The monitoring module 151 is also connected to the DE 130 and relays access to data in the DE 130. When the CM 111 is activated, before the CPU 155 starts its processing, the monitoring module 151 checks connection to the SVCs 121 and 122. This connection check may be implemented as one of the checks, e.g., power-on self-test (POST), performed by the basic input and output system (BIOS) executed by the monitoring module 151.

The FPGA 152 relays data communication between the SVCs 121 and 122 and the monitoring module 151 and between the SVCs 121 and 122 and the CPU 155 via the ports P0 and P1. In addition, the FPGA 152 reads a firmware program or data stored in the MRAM 153 and supplies the read program or data to the monitoring module 151 or the CPU 155. The FPGA 152 is also connected to an FPGA 152a of the CM 112 and is able to perform FPGA communication.

The MRAM 153 is a non-volatile memory that holds a firmware program executed by the monitoring module 151 or the CPU 155 and data used for firmware processing. In place of or in addition to the MRAM 153, a different non-volatile memory such as a flash memory may be used.

The PEX 154 provides a data transmission line between the CM 111 and the DE 130. PCI express is used for the transmission line. For example, the PEX 154 provides a transmission line for accessing data in the DE 130 via the SAN 40.

The CPU 155 is a processor that controls the CM 111. After the monitoring module 151 finishes the connection check, the CPU 155 loads firmware from the MRAM 153 to the DIMM 156 and executes the firmware. Thus, the CPU 155 starts data access control on the DE 130.

The DIMM 156 is a memory that holds a firmware program or various types of data executed by the CPU 155.

The communication IF 157 is a communication interface (for example, Ethernet (registered trademark) connected to the network 30. The communication IF 157 communicates with the operation server 200 via the network 30.

The IOC 158 is a module that controls data access such as reading and writing of data on the DE 130.

The CA 159 is a communication interface connected to the SAN 40. The CM 111 may include a plurality of CAs 159 and form redundant paths that are connected to the SAN 40. The CM 111 also includes non-transparent bridges (NTBs) (not illustrated in FIG. 7) connected to the FRTs 140 and 140a.

The CM 112 includes the ports P2 and P3, the monitoring module 151a, the FPGA 152a, an MRAM 153a, a PEX 154a, a CPU 155a, a DIMM 156a, a communication IF 157a, an IOC 158a, and the CA 159a. The ports P2 and P3 are interfaces for connecting the CM 112 to the SVCs 121 and 122, respectively, as described above. Since the monitoring module 151a, the FPGA 152a, the MRAM 153a, the PEX 154a, the CPU 155a, the DIMM 156a, the communication IF 157a, the IOC 158a, and the CA 159a are hardware components that function in the same way as the above hardware components of the CM 111, redundant description thereof will be omitted.

The SVC 121 includes the ports Pa0, Pa1, Pa2, Pa3, . . . , and Pa(n+1), a micro-processing unit (MPU) 161, a DIMM 162, an FPGA 163, and an MRAM 164. The SVC 122 is realized by the same hardware components as those of the SVC 121.

The MPU 161 is a processor that controls the SVC 121. The MPU 161 loads a firmware program stored in the MRAM 164 to the DIMM 162 and executes the firmware program, to perform power supply control and monitoring processing on each of the CMs.

The DIMM 162 is a memory that holds a firmware program or various types of data executed by the MPU 161.

The FPGA 163 relays data communication between the MPU 161 and each of the CMs via the ports Pa0, Pa1, Pa2, Pa3, . . . , and Pa(n+1). The FPGA 163 is also connected to the FE-BRG 123. The FPGA 163 relays data communication between the MPU 161 and the SVC 122 via the FE-BRG 123. In addition, the FPGA 163 reads a firmware program or data stored in the MRAM 164 and supplies the read program or data to the MPU 161.

The MRAM 164 is a non-volatile memory that holds a firmware program executed by the MPU 161 and data used for firmware processing. In place of or in addition to the MRAM 164, a different non-volatile memory such as a flash memory may be used.

The DE 130 includes an input and output module (IOM) 131. When the IOM 131 receives a data access request (read request or write request) from any one of the CMs 111 and 112, in response to the request, the IOM 131 accesses an HDD or SSD included in the DE 130 (performs data reading and data writing). The DE 130 transmits a processing result corresponding to the access request to the corresponding one of the CMs 111 and 112.

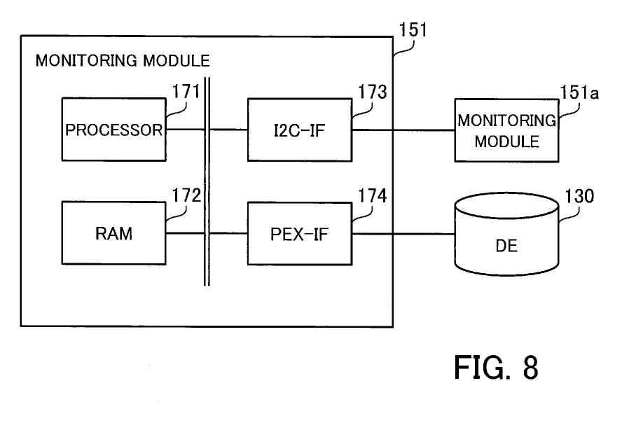

FIG. 8 illustrates examples of hardware components of the monitoring module 151 according to the second embodiment. The monitoring module 151 includes a processor 171, a RAM 172, an I2C-IF 173, and a PEX-IF 174. The monitoring module 151a is realized by the same hardware components as those of the monitoring module 151.

The processor 171 controls information processing of the monitoring module 151. The processor 171 may be a multiprocessor. Examples of the processor 171 include a CPU, a DSP, an ASIC, and an FPGA. The processor 171 may be a combination of at least two of a CPU, a DSP, an ASIC, an FPGA, and the like.

The RAM 172 is a main storage device of the monitoring module 151. The RAM 172 temporarily holds at least a part of a firmware program executed by the processor 171. The RAM 172 holds various types of data used for processing of the processor 171. In addition to the RAM 172, the monitoring module 151 may include a non-volatile memory that holds a firmware program executed by the processor 171.

The I2C-IF 173 is an I2C interface connected to the monitoring module 151a.

The PEX-IF 174 is a PCI-Express interface connected to the DE 130.

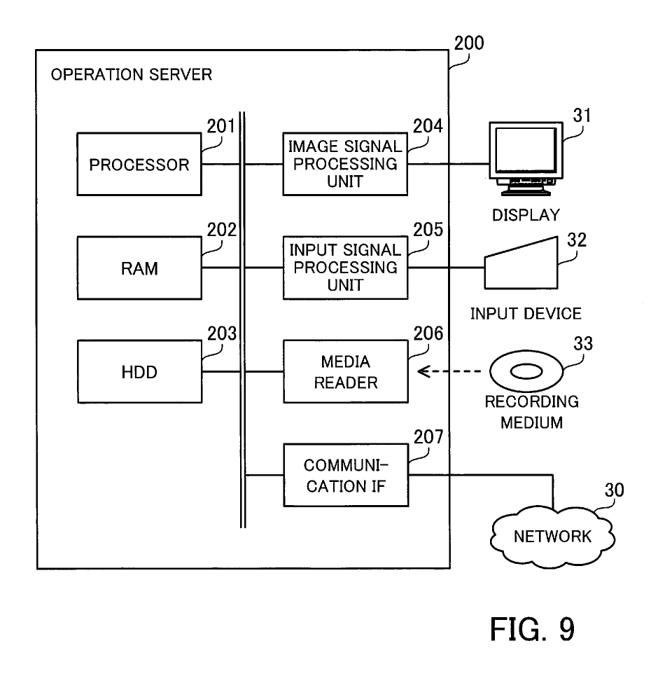

FIG. 9 illustrates an example of the operation server 200 according to the second embodiment. The operation server 200 includes a processor 201, a RAM 202, an HDD 203, an image signal processing unit 204, an input signal processing unit 205, a media reader 206, and a communication IF 207. These units are connected to a bus of the operation server 200. The business server 300 is also realized by the same hardware components as those of the operation server 200.

The processor 201 controls information processing of the operation server 200. The processor 201 may be a multiprocessor. Examples of the processor 201 include a CPU, a DSP, an ASIC, and an FPGA. The processor 201 may be a combination of at least two of a CPU, a DSP, an ASIC, an FPGA, and the like.

The RAM 202 is a main storage device of the operation server 200. The RAM 202 temporarily holds at least a part of an operating system (OS) program or an application program executed by the processor 201. In addition, the RAM 202 holds various types of data used for processing of the processor 201.

The HDD 203 is an auxiliary storage device of the operation server 200. The HDD 203 magnetically reads and writes data on an internal magnetic disk. The HDD 203 stores an OS program, an application program, and various types of data. The operation server 200 may include a different kind of auxiliary storage device such as a flash memory or an SSD and may include a plurality of auxiliary storage devices.

The image signal processing unit 204 outputs an image to a display 31 connected to the operation server 200 in accordance with a command from the processor 201. Examples of the display 31 include a cathode ray tube (CRT) display and a liquid crystal display.

The input signal processing unit 205 acquires an input signal from an input device 32 connected to the operation server 200 and outputs the input signal to the processor 201. Examples of the input device 32 include a pointing device such as a mouse or a touch panel and a keyboard.

The media reader 206 is a device that reads a program or data recorded in the recording medium 33. Examples of the recording medium 33 include a magnetic disk such as a flexible disk (FD) or an HDD, an optical disc such as a compact disc (CD) or a digital versatile disc (DVD), and a magneto-optical disk (MO). In addition, for example, a non-volatile semiconductor memory such as a flash memory card may be used as the recording medium 33. The media reader 206 stores a program or data read from the recording medium 33 in the RAM 202 or the HDD 203 in accordance with a command from the processor 201, for example.

The communication IF 207 communicates with other devices such as the storage system 100 via the network 30. The communication IF 207 may be a wired or wireless communication interface.

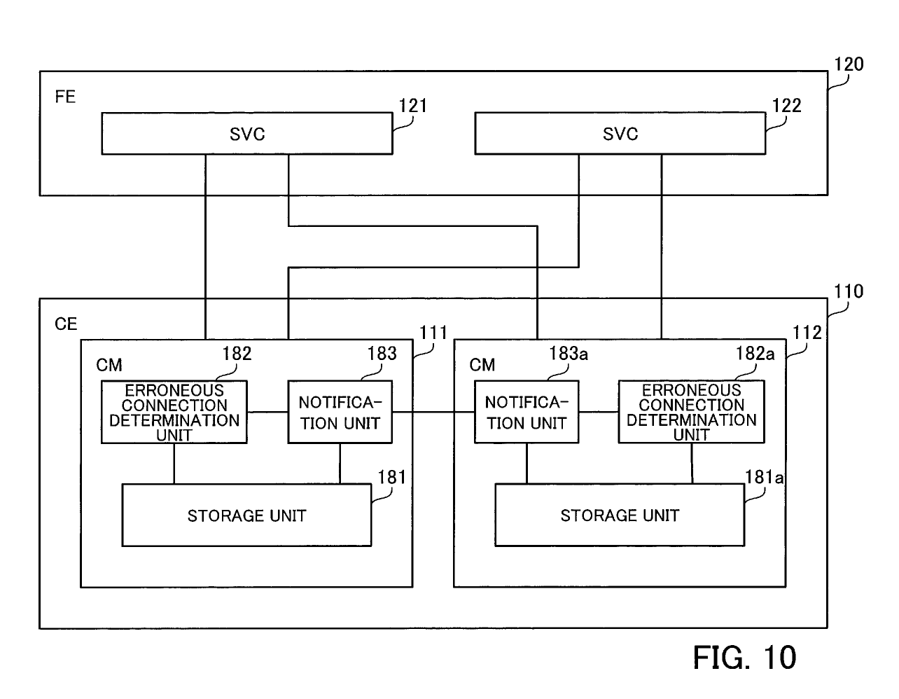

FIG. 10 illustrates examples of functions of the CMs 111 and 112 according to the second embodiment. The CM 111 includes a storage unit 181, an erroneous connection determination unit 182, and a notification unit 183. For example, the storage unit 181 is realized as a storage area ensured in the RAM 172. For example, each of the erroneous connection determination unit 182 and the notification unit 183 is realized by causing the processor 171 to execute a program stored in the RAM 172.

The storage unit 181 holds data used for processing performed by the erroneous connection determination unit 182 and the notification unit 183. For example, the storage unit 181 holds information about the connection destination port number of the CM 111 and the connection destination port number of the CM 112 acquired from the CM 112. In addition, for example, the storage unit 181 holds information about the IDs of the CM 111 and the CE 110 determined by the erroneous connection determination unit 182.

The erroneous connection determination unit 182 performs matching processing by using the ports P0 and P1 and the port numbers (connection destination port numbers) of the ports (connection destination ports) of the SVCs 121 and 122 connected to the ports P0 and P1. In addition, on the basis of the result of the matching processing and the result of the matching processing obtained by the CM 112, the erroneous connection determination unit 182 determines whether the ports P0 and P1 are erroneously connected to the SVCs 121 and 122 via cables.

To perform this determination processing, the storage unit 181 previously holds information about criteria for determining a correct connection configuration. If all the following connection conditions are satisfied, the erroneous connection determination unit 182 determines that a correct connection configuration is established.

Connection condition (1): Each of the port numbers of the ports of the target CM is the same as the slot number of the corresponding connection destination SVC to which this port is connected.

Connection condition (2): All of the slot number of the CM and the corresponding port numbers of the connection destination SVCs are even numbers or odd numbers (“0” is considered to be an even number herein).

Connection condition (3): The same connection destination port number is received via both of the ports which are included in the same CM and whose port numbers are “0” and “1.”

Connection condition (4): The connection destination port numbers received by the two CMs that belong to the same CE are consecutive numbers.

The erroneous connection determination unit 182 determines whether the CM 111 is correctly connected to the SVCs 121 and 122 by checking the above connection conditions (1) to (4), namely, by performing step-by-step matching processing by using the slot numbers and the connection destination port numbers of the SVCs and the reception port numbers and the slot number of the CM 111.

The notification unit 183 transmits data to the SVCs 121 and 122 and the CM 112. For example, the notification unit 183 notifies the CM 112 of the port number matching result of the CM 111. In addition, the notification unit 183 notifies the SVCs 121 and 122 of the erroneous connection determination result of the CM 111.

The CM 112 includes a storage unit 181a, an erroneous connection determination unit 182a, and a notification unit 183a. For example, the storage unit 181a is realized as a storage area ensured in the RAM of the monitoring module 151a. For example, each of the erroneous connection determination unit 182a and the notification unit 183a is realized by causing the processor of the monitoring module 151a to execute a program stored in the RAM of the monitoring module 151a.

The storage unit 181a, the erroneous connection determination unit 182a, and the notification unit 183a function in the same way as the above corresponding units of the CM 111. Namely, the erroneous connection determination unit 182a performs matching processing by using the port numbers of the ports P2 and P3 and the port numbers (connection destination port numbers) of the ports (connection destination ports) of the SVCs 121 and 122 to which the ports P2 and P3 are connected. In addition, the erroneous connection determination unit 182a determines whether the ports P2 and P3 and the SVCs 121 and 122 are correctly connected via cables on the basis of the result of the matching processing and the result of the matching processing obtained from the CM 111. The notification unit 183a transmits data to the SVCs 121 and 122 and the CM 111. For example, the notification unit 183a notifies the CM 111 of the port number matching result of the CM 112. The notification unit 183a notifies the SVCs 121 and 122 of the erroneous connection determination result of the CM 112.

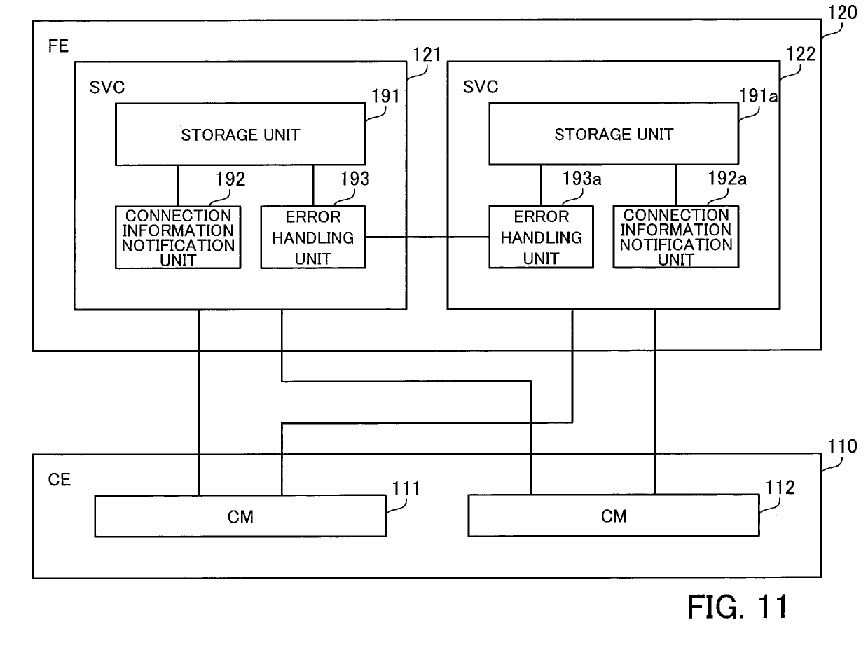

FIG. 11 illustrates examples of functions of the SVCs according to the second embodiment. The SVC 121 includes a storage unit 191, a connection information notification unit 192, and an error handling unit 193. For example, the storage unit 191 is realized as a storage area ensured in the DIMM 162. For example, each of the connection information notification unit 192 and the error handling unit 193 is realized by causing the MPU 161 to execute a program stored in the DIMM 162.

The storage unit 191 holds data used for processing of the connection information notification unit 192 and the error handling unit 193. For example, the storage unit 191 holds information about a correspondence relationship among the port numbers of the ports of the SVC 121 and the IDs of the CMs and the CEs connected to the ports. In addition, for example, the storage unit 191 holds the erroneous cable connection determination results transmitted from the CMs 111 and 112.

The connection information notification unit 192 notifies the CMs connected to ports of the SVC 121 of connection information about the SVC 121. The connection information includes the port numbers (connection destination port numbers) of the ports (connection destination ports) of the SVC 121 to which the CMs are connected and the slot number of the SVC 121.

The error handling unit 193 performs error handling (for improving reliability so that the storage system 100 is operated stably), on the basis of the erroneous connection determination results transmitted from the CMs. This error handling for improving reliability is often referred to as reliability, availability and serviceability (RAS) processing. More specifically, the error handling unit 193 performs control processing for preventing a CM that is erroneously connected (that has caused a connection error) from being used in the storage system 100 and generates error information, for example. The FE 120 includes an operation panel that receives instructions from users. The operation panel is provided with a plurality of LEDs corresponding to the installation locations of the respective CMs. The error handling unit 193 controls the operation panel of the FE 120 and lights up the LED corresponding to the installation location of an erroneously connected CM in a color indicating an error or blinks this LED in a period indicating an error.

The SVC 122 includes a storage unit 191a, a connection information notification unit 192a, and an error handling unit 193a. For example, the storage unit 191a is realized as a storage area ensured in the DIMM of the SVC 122. For example, each of the connection information notification unit 192a and the error handling unit 193 is realized by causing the MPU of the SVC 122 to execute a program stored in the DIMM of the SVC 122.

The storage unit 191a, the connection information notification unit 192a, and the error handling unit 193a function in the same way as the corresponding units of the SVC 121. Namely, the connection information notification unit 192a notifies the CMs connected to ports of the SVC 122 of connection information about the SVC 122. The connection information includes the port numbers (connection destination port numbers) of the ports (connection destination ports) of the SVC 122 to which the CMs are connected and the slot number of the SVC 122.

The error handling unit 193a performs error handling on the basis of the erroneous connection determination results transmitted from the CMs. The error handling units 193 and 193a may coordinate with each other and only one of the error handling units 193 and 193a may perform the error handling.

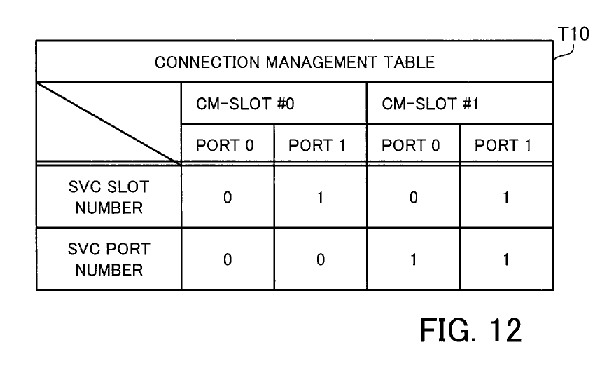

FIG. 12 illustrates an example of a connection management table T10 according to the second embodiment. The connection management table T10 is stored in the storage unit 181. The connection management table T10 is a table for managing the connection information acquired by the CMs 111 and 112 from the SVCs 121 and 122.

In the connection management table T10, connection information about the port P0 (“port 0” in FIG. 12) and the port P1 (“port 1” in FIG. 12) of the CM 111 (“CM-slot #0” in FIG. 12) is registered. As described above, the connection information received via a port includes the slot number (“SVC slot number” in FIG. 12) of the connection destination SVC and the corresponding port number (“SVC port number” in FIG. 12) of the connect destination SVC.

Likewise, in the connection management table T10, connection information about the port P2 (“port 0” in FIG. 12) and the port P3 (“port 1” in FIG. 12) of the CM 112 (“CM-slot #1” in FIG. 12) is registered.

For example, in the case of the connection between the CE 110 and the FE 120 illustrated in FIG. 6, the port P0 is given “0” as the SVC slot number (the slot number of the SVC 121) and “0” as the SVC port number (the port number of the port Pa0). The port P1 is given “1” as the SVC slot number (the slot number of the SVC 122) and “0” as the SVC port number (the port number of the port Pb0). The port P2 is given “0” as the SVC slot number (the slot number of the SVC 121) and “1” as the SVC port number (the port number of the port Pa1). The port P3 is given “1” as the SVC slot number (the slot number of the SVC 122) and “1” as the SVC port number (the port number of the port Pb1).

Next, connection determination processing performed when the storage system 100 is activated will be described. While the following description will be made with a focus on the SVC 121 and the CM 111, other SVCs including the SVC 122 and other CMs including the CM 112 perform like processing.

When the storage system 100 is activated, first, the SVCs 121 and 122 are activated. Each of the SVCs 121 and 122 checks a link with the CMs and turns on the power supplies for the CMs. In this operation, each of the CMs determines whether an individual path between the CM and the SVCs 121 and 122 is correctly connected.

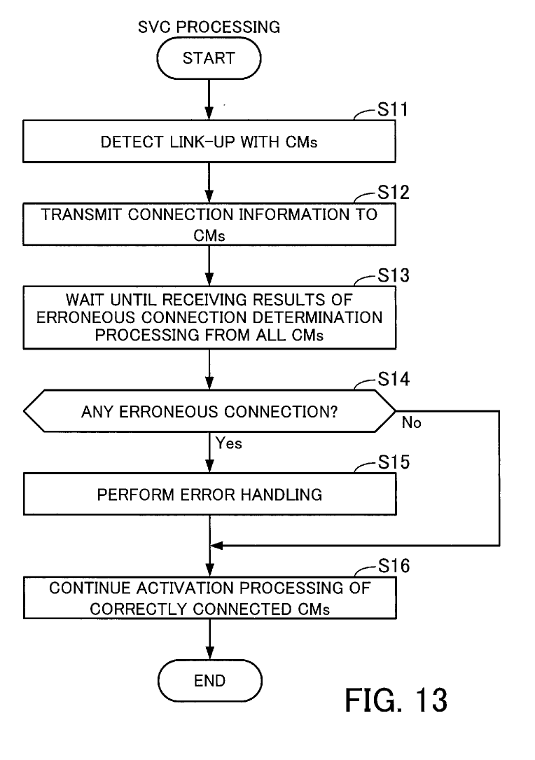

FIG. 13 is a flowchart illustrating an example of processing performed by an SVC according to the second embodiment. Hereinafter, the processing illustrated in FIG. 13 will be described in accordance with step numbers.

(S11) The connection information notification unit 192 detects a link-up between the CM 111 and the SVC 121 (connection between ports of the CM 111 and the SVC 121). Likewise, the connection information notification unit 192 detects a link-up between a different CM such as the CM 112 and the SVC 121.

(S12) The connection information notification unit 192 transmits connection information to the CM 111 via the link-up port. The connection information includes the slot number of the SVC 121 and the port number (connection destination port number) of the corresponding port of the SVC 121. The connection information notification unit 192 transmits the port number of the port of the SVC 121, the ports being connected to the corresponding port of the CM 111, as the port number. For example, in the case of the connection in FIG. 6, the connection information notification unit 192 transmits the slot number “0” of the SVC 121 and the port number “0” of the port Pa0 to the CM 111 via the port Pa0. In addition, the connection information notification unit 192 transmits the slot number “0” of the SVC 121 and the port number “1” of the port Pa1 to the CM 112 via the port Pa1.

(S13) The error handling unit 193 waits until receiving erroneous connection determination results obtained by all the CMs connected to the SVC 121. When the error handling unit 193 receives the erroneous connection determination results from the CMs, the processing proceeds to step S14.

(S14) The error handling unit 193 determines whether any of the ports of the SVC 121 is erroneously connected on the basis of the information about the determination results acquired in step S13. If any of the ports is erroneously connected, the processing proceeds to step S15. If all the ports are correctly connected, the processing proceeds to step S16.

(S15) The error handling unit 193 performs error handling. For example, the error handling unit 193 transmits data that instructs cancelation of the activation processing from the erroneously connected port of the SVC 121. In this way, the activation processing of the erroneously connected CM is canceled. Next, the processing proceeds to step S16.

(S16) The error handling unit 193 continues the activation processing of the correctly connected CMs (CMs that have transmitted determination results indicating no erroneous connections). For example, the error handling unit 193 transmits data that instructs continuation of the activation processing from the correctly connected ports of the SVC 121. In this way, the activation processing of the correctly connected CMs is continued. Next, the processing proceeds to END.

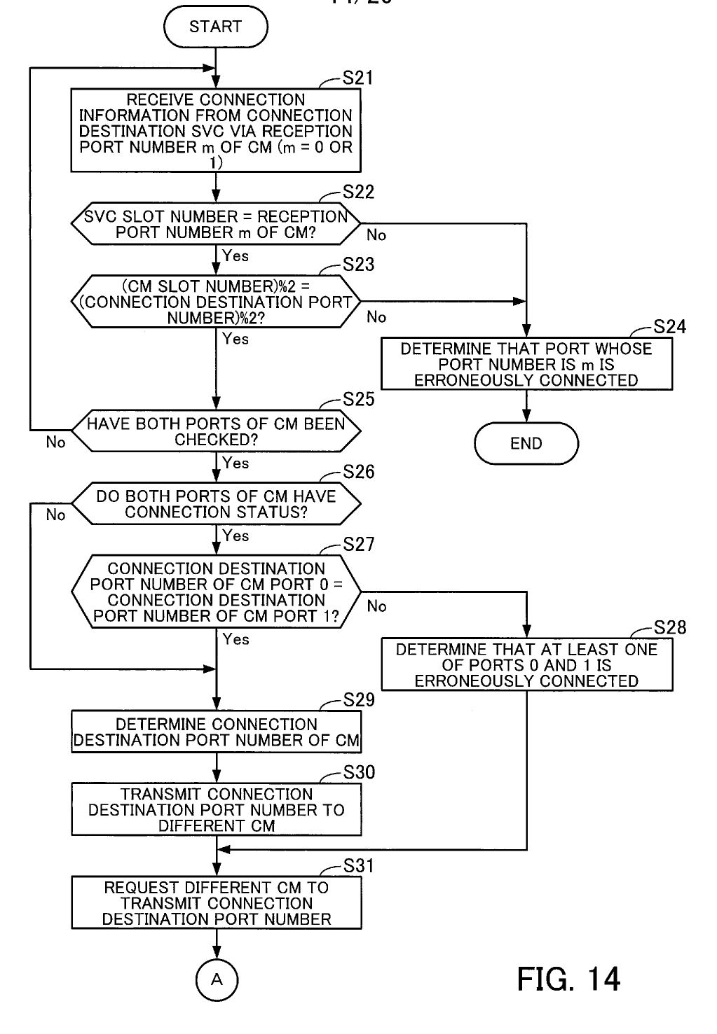

FIG. 14 is a flowchart illustrating an example of processing performed by a CM according to the second embodiment. Hereinafter, the processing illustrated in FIG. 14 will be described in accordance with step numbers.

(S21) The erroneous connection determination unit 182 of the CM 111 receives connection information (including a slot number and connection destination port numbers of a connection destination SVC) from the connection destination SVC (the SVC 121 or the SVC 122). The erroneous connection determination unit 182 associates the received connection information with a port number m (reception port number m) of the CM 111 that has received the connection information and stores the associated information in the connection management table T10. The reception port number m of the CM 111 is 0 or 1. The erroneous connection determination unit 182 performs the next steps S22 and S23 on the basis of the connection information received in step S21 (the connection information about the SVC 121 or the SVC 122).

(S22) The erroneous connection determination unit 182 determines whether the SVC slot number matches the reception port number m of the CM 111 (namely, whether the SVC slot number is the same as the reception port number m). If these numbers match, the processing proceeds to step S23. If not, the processing proceeds to step S24. In step S22, the erroneous connection determination unit 182 determines whether the port number of the receiving port of the CM 111 is the same as the slot number of the connection destination SVC to which the receiving port is connected (whether the connection condition (1) is satisfied).

(S23) The erroneous connection determination unit 182 determines whether the remainder obtained by dividing the slot number of the CM 111 by 2 matches the remainder obtained by dividing the connection destination port number by 2. If the remainders match, the processing proceeds to step S25. If not, the processing proceeds to step S24. In FIG. 14, this determination is expressed as “(CM slot number) %2=(connection destination port number) %2?.” This “%2” indicates an operation of acquiring the remainder by dividing a dividend by 2. In step S23, the erroneous connection determination unit 182 determines whether both the slot number of the CM 111 and the port number of the connection destination SVC are even numbers or odd numbers (whether the connection condition (2) is satisfied).

(S24) The erroneous connection determination unit 182 determines that the port whose port number is m is erroneously connected. Next, the erroneous connection determination unit 182 ends the present processing. If the erroneous connection determination unit 182 has performed the present determination processing on only one of the ports P0 and P1 of the CM 111, the erroneous connection determination unit 182 may perform steps S22 and S23 for the other one of the ports P0 and P1. In this way, after determining whether the other one of the ports P0 and P1 is erroneously connected, the erroneous connection determination unit 182 can end the present processing.

(S25) The erroneous connection determination unit 182 determines whether both of the ports (the ports P0 and P1) of the CM 111 have been checked in steps S22 and S23. If so, the processing proceeds to step S26. If not, the processing returns to step S21. The erroneous connection determination unit 182 may perform steps S21 to S23 only on a link-up port(s) (connected to an SVC(s)). If one of the ports P0 and P1 is not connected, the processing proceeds to step S26 without checking this port that is not connected to any SVC. In this case, the status (connection status) of the unconnected port is managed as having no status or an abnormality. In contrast, the connection status of the connected port is managed as having a status.

(S26) The erroneous connection determination unit 182 determines whether both of the ports of the CM 111 have a connection status. If both of the ports have a connection status, the processing proceeds to step S27. If any one of the ports does not have a connection status (or has a connection status indicating an abnormality), the processing proceeds to step S29.

(S27) The erroneous connection determination unit 182 determines whether the connection destination port numbers of the ports P0 and P1 of the CM 111 match. If the connection destination port numbers match, the processing proceeds to step S29. If not, the processing proceeds to step S28. In FIG. 14, since the port numbers of the ports P0 and P1 are “0” and “1,” the ports P0 and P1 are represented as “port 0” and “port 1,” respectively (the ports P0 and P1 will hereinafter be represented in this way as needed). Thus, the determination in FIG. 14 is represented as “connection destination port number of CM port 0=connection destination port number of CM port 1?” In step S27, the erroneous connection determination unit 182 determines whether the connection condition (3) is satisfied.

(S28) The erroneous connection determination unit 182 determines that the port 0 or 1 (namely, the port P0 or P1) is erroneously connected. Next, the processing proceeds to step S31.

(S29) The erroneous connection determination unit 182 determines the connection destination port number of its own CM (CM 111). More specifically, if “No” is determined in step S26, the erroneous connection determination unit 182 determines the connection destination port number included in the connection destination information acquired via one port to be the connection destination port number of the CM 111. If “Yes” is determined in step S27, the erroneous connection determination unit 182 determines the connection destination port number received via both of the ports of the CM 111 to be the connection destination port number of the CM 111.

(S30) The notification unit 183 transmits the determined connection destination port number to a different CM (the CM 112) that belongs to the CE 110 to which its own CM (the CM 111) also belongs. For example, the notification unit 183 may transmit the determined connection destination port number to the CM 112 in response to a connection destination port acquisition request from the CM 112.

(S31) The erroneous connection determination unit 182 requests the different CM to transmit a connection destination port number determined through the matching processing by the different CM (the CM 112) that belongs to the CE 110 to which its own CM (CM 111) also belongs.

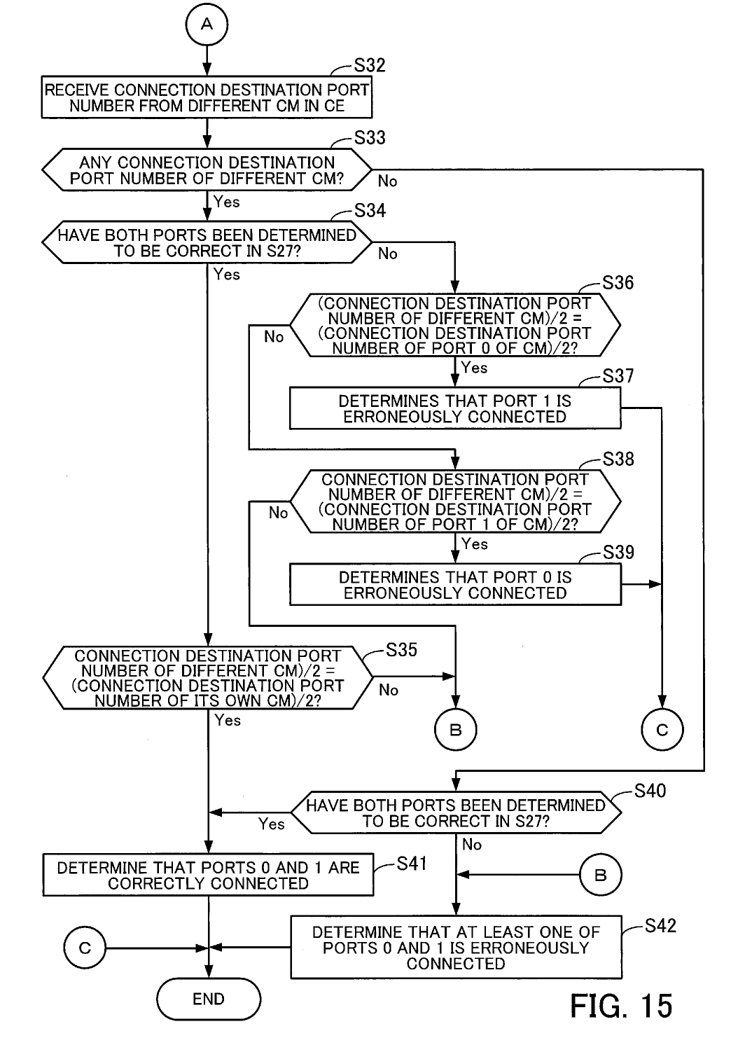

FIG. 15 is a flowchart illustrating steps that follow the steps in FIG. 14. Hereinafter, the processing illustrated in FIG. 15 will be described in accordance with step numbers.

(S32) The erroneous connection determination unit 182 receives the connection destination port number of the different CM (the CM 112) in the CE 110. There are cases in which the connection destination port of the CM 112 has not been determined yet through the matching processing performed by the CM 112. In such cases, the erroneous connection determination unit 182 obtains a matching result indicating no connection destination port number or an abnormality from the CM 112 in response to the request in step S31.

(S33) The erroneous connection determination unit 182 determines whether there is any connection destination port number of the different CM (the CM 112). If so, the processing proceeds to step S34. If not (or if there is an abnormality), the processing proceeds to step S40. If the erroneous connection determination unit 182 receives a connection destination port number determined by the CM 112 from the CM 112 in step S32, the processing proceeds to step S34. In contrast, if the erroneous connection determination unit 182 receives a matching result indicating no connection destination port number or an abnormality from the CM 112 in step S32, the processing proceeds to step S40.

(S34) The erroneous connection determination unit 182 determines whether both of the ports have been determined to be correct in step S27. If both of the ports are correct, the processing proceeds to step S35. If not, the processing proceeds to step S36. If it is determined that the connection destination port numbers acquired via the respective ports match in step S27, the erroneous connection determination unit 182 determines that both of the ports have been determined to be correct in step S27. However, if “No” is determined in step S26, the erroneous connection determination unit 182 exceptionally determines that both of the ports have been determined to be correct (namely, “Yes” is determined in step S34). Other than the above cases, the erroneous connection determination unit 182 determines that both of the ports have not been determined to be correct (namely, the erroneous connection determination unit 182 determines that at least one of the ports is abnormal).

(S35) The erroneous connection determination unit 182 determines whether the quotient obtained by dividing the connection destination port number of the different CM (the CM 112) by 2 matches the quotient obtained by dividing the connection destination port number of its own CM (CM 111) by 2. If these quotients match, the processing proceeds to step S41. If not, the processing proceeds to step S42. In FIG. 15, this determination is represented as “(connection destination port number of different CM)/2=(connection destination port number of its own CM)/2?” This “/2” indicates an operation of acquiring the quotient obtaining by dividing a dividend by 2 (“/2” indicates the same operation in the following steps). In step S35, the erroneous connection determination unit 182 determines whether the connection destination port numbers received by its own CM and the different CM that belong to the same CE are consecutive numbers (whether the connection condition (4) is satisfied).

(S36) The erroneous connection determination unit 182 determines whether the quotient obtained by dividing the connection destination port number of the different CM (the CM 112) by 2 matches the quotient obtained by dividing the connection destination port number acquired via the port P0 of its own CM (the CM 111) by 2. If these quotients match, the processing proceeds to step S37. If not, the processing proceeds to step S38. In FIG. 15, this determination is represented as “(connection destination port number of different CM)/2=(connection destination port number of port 0 of CM)/2?” In step S36, the erroneous connection determination unit 182 determines whether the connection destination port number received via the port P0 of the CM 111 and the connection destination port number received by the different CM, both of the CMs belonging to the same CE, are consecutive numbers (whether the connection condition (4) is satisfied).

(S37) The erroneous connection determination unit 182 determines that the port 1 (namely, the port P1) is erroneously connected. This is because the erroneous connection determination unit 182 determines that the port P0 is correctly connected if “Yes” is determined in step S36. Next, the erroneous connection determination unit 182 ends the present processing.

(S38) The erroneous connection determination unit 182 determines whether the quotient obtained by dividing the connection destination port number of the different CM (the CM 112) by 2 matches the quotient obtained by dividing the connection destination port number acquired via the port P1 of its own CM (the CM 111) by 2. If these quotients match, the processing proceeds to step S39. If not, the processing proceeds to step S42. In FIG. 15, this determination is represented as “(connection destination port number of different CM)/2=(connection destination port number of port 1 of CM)/2?” In step S38, the erroneous connection determination unit 182 determines whether the connection destination port number received via the port P1 of the CM 111 and the connection destination port number received by the different CM, both of the CMs belonging to the same CE, are consecutive numbers (whether the connection condition (4) is satisfied).

(S39) The erroneous connection determination unit 182 determines that the port 0 (namely, the port P0) is erroneously connected. This is because the erroneous connection determination unit 182 determines that the port P1 is correctly connected if “Yes” is determined in step S38. Next, the erroneous connection determination unit 182 ends the present processing.

(S40) The erroneous connection determination unit 182 determines whether both of the ports have been determined to be correct in step S27. If both of the ports are correct, the processing proceeds to step S41. If not, the processing proceeds to step S42. If it is determined that the connection destination port numbers acquired via the respective ports match in step S27, the erroneous connection determination unit 182 determines that both of the ports have been determined to be correct in step S27. However, if “No” is determined in step S26, the erroneous connection determination unit 182 exceptionally determines that both of the ports have been determined to be correct (namely, “Yes” is determined in step S40). Other than the above cases, the erroneous connection determination unit 182 determines that both of the ports have not been determined to be correct (namely, the erroneous connection determination unit 182 determines that at least one of the ports is abnormal).

(S41) The erroneous connection determination unit 182 determines that the ports 0 and 1 (namely, the ports P0 and P1) are correctly connected. If “No” is determined in step S26, the erroneous connection determination unit 182 determines that the corresponding one of the ports 0 and 1 is correctly connected. Next, the erroneous connection determination unit 182 ends the present processing.

(S42) The erroneous connection determination unit 182 determines that at least one of the ports 0 and 1 (namely, at least one of the ports P0 and P1) is erroneously connected. Next, the erroneous connection determination unit 182 ends the present processing.

In this way, the erroneous connection determination unit 182 determines whether the CM 111 is correctly connected to the SVCs 121 and 122. The notification unit 183 transmits information indicating whether each of the corresponding ports is erroneously connected to the SVC 121 or 122 to the SVCs 121 and 122. For example, if the erroneous connection determination unit 182 determines that a port and a connection destination port are erroneously connected to each other, the notification unit 183 may transmit information indicating this erroneous connection to the connection destination port. In addition, if the erroneous connection determination unit 182 determines that a port and a connection destination port are correctly connected to each other, the notification unit 183 may transmit information indicating this correct connection to the connection destination port. Next, an example of the processing performed by the CMs 111 and 121 and the SVCs 121 and 122 in accordance with the above flowchart will be described.

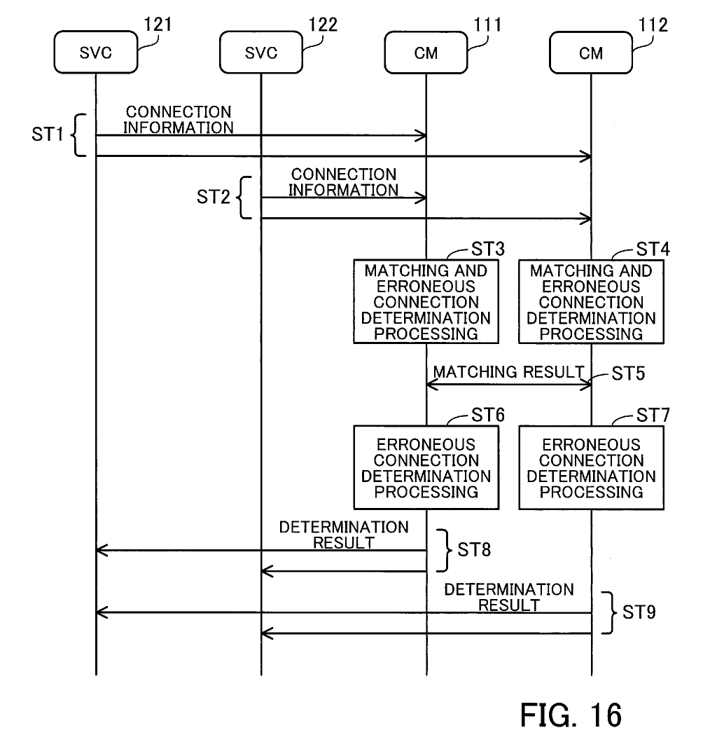

FIG. 16 is an example of a sequence illustrating processing according to the second embodiment. Hereinafter, the processing illustrated in FIG. 16 will be described in accordance with step numbers.

(ST1) The power supply of the SVC 121 is turned on. The SVC 121 detects that the CMs 111 and 112 are connected to its ports and transmits respective connection information via the ports. The respective connection information includes the slot number of the SVC 121 and the port numbers of the corresponding ports. For example, the CMs 111 and 112 receive the respective connection information from the SVC 121.

(ST2) The power supply of the SVC 122 is turned on. The SVC 122 detects that the CMs 111 and 112 are connected to its ports and transmits respective connection information via the ports. The respective connection information includes the slot number of the SVC 122 and the port numbers of the corresponding ports. For example, the CMs 111 and 112 receive the respective connection information from the SVC 122. These steps ST1 and ST2 may be performed in parallel or in reverse order.

(ST3) On the basis of the connection conditions (1) to (3), the CM 111 performs matching processing by using the slot numbers and the connection destination port numbers of the SVCs 121 and 122 and the reception port numbers and the slot number of the CM 111. As illustrated in FIG. 14, there are cases in which the CM 111 detects that any of the ports is erroneously connected by performing the matching processing.

(ST4) On the basis of the connection conditions (1) to (3), the CM 112 also performs matching processing by using the slot numbers and the connection destination port numbers of the SVCs 121 and 122 and the reception port numbers and the slot number of the CM 112. As illustrated in FIG. 14, there are cases in which the CM 112 detects that any of the ports is erroneously connected by performing the matching processing. These steps ST3 and ST4 may be performed in parallel or in reverse order.

(ST5) The CM 111 transmits the result of the matching processing obtained in step ST3 to the CM 112. The CM 112 transmits the result of the matching processing obtained in step ST4 to the CM 111. In this way, the CMs 111 and 112 that belong to the CE 110 share the results of the matching processing obtained in steps ST3 and ST4.

(ST6) The CM 111 refers to the results of the matching processing obtained by the CMs 111 and 112 and determines whether the ports P0 and P1 are erroneously connected on the basis of the connection condition (4). As illustrated in FIG. 15, even when the CM 111 detects no erroneous connections relating to any of the ports in step ST3, the CM 111 could detect erroneous connections in step ST6. In addition, even if the CM 111 detects an erroneous connection in step ST3, the CM 111 may not be able to determine which port is erroneously connected. However, by performing step ST6, the CM 111 could determine an erroneously connected port even in such cases.

(ST7) In the same way as the CM 111 does, the CM 112 determines whether the ports P2 and P3 are erroneously connected on the basis of the connection condition (4). As illustrated in FIG. 15, even when the CM 112 detects no erroneous connections relating to any of the ports in step ST4, the CM 112 could detect erroneous connections in step ST7. In addition, even if the CM 112 detects an erroneous connection in step ST4, the CM 112 may not be able to determine which port is erroneously connected. However, by performing step ST7, the CM 112 could determine an erroneously connected port even in such cases. These steps ST6 and ST7 may be performed in parallel or in reverse order.

(ST8) The CM 111 transmits the result of the erroneous connection determination processing about the ports P0 and P1 to the SVCs 121 and 122. For example, when the port P0 is connected to the port Pa0 of the SVC 121, the CM 111 transmits information indicating whether the port P0 is erroneously connected to the port Pa0 via the port P0. For example, when the port P1 is connected to the port Pb0 of the SVC 122, the CM 111 transmits information indicating whether the port P1 is erroneously connected to the port Pa1 via the port P1.

(ST9) The CM 112 transmits the result of the erroneous connection determination processing about the ports P2 and P3 to the SVCs 121 and 122. For example, when the port P2 is connected to the port Pa1 of the SVC 121, the CM 112 transmits information indicating whether the port P2 is erroneously connected to the port Pa1 via the port P2. For example, when the port P3 is connected to the port Pica of the SVC 122, the CM 112 transmits information indicating whether the port P3 is erroneously connected to the port Pb1 via the port P3.

In this way, the SVCs 121 and 122 recognize whether the SVCs 121 and 122 are erroneously connected to the CMs 111 and 112 by receiving the determination results from the CMs 111 and 112. If the SVCs 121 and 122 detect an erroneous connection, the SVCs 121 and 122 performs predetermined error handling. Hereinafter, specific examples of how erroneous connections are detected will be descried by using several erroneous connection patterns. The following description will be made assuming that the FE 120 is erroneously connected to at least one of the CEs 110 and 110a from the correct connection illustrated in FIG. 6. In addition, while the following description will be made with a focus on erroneously connected ports or unconnected ports with reference to the following drawings, the following description assumes that the other ports are connected as illustrated in FIG. 6.

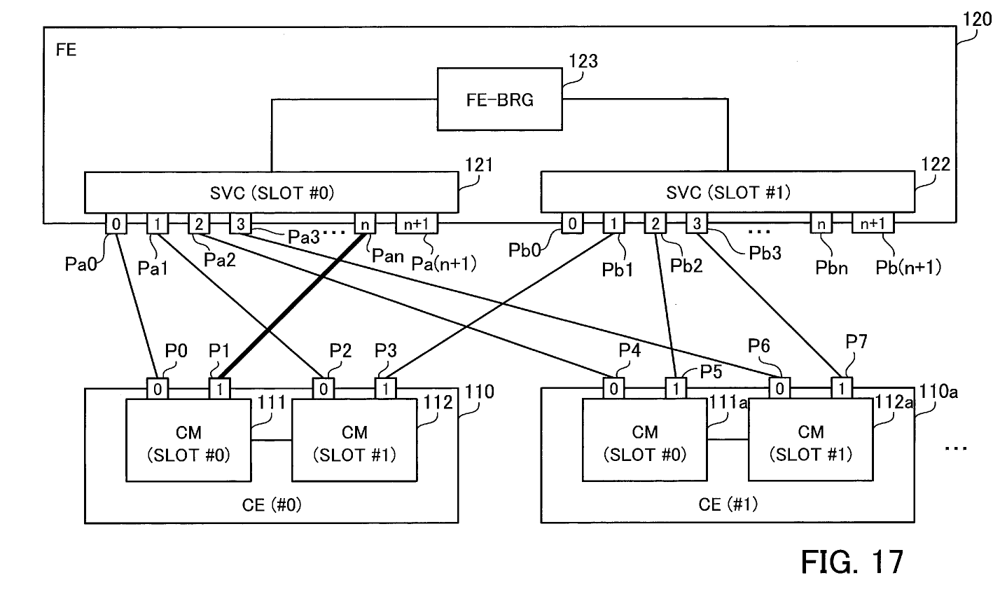

FIG. 17 illustrates example 1 of erroneous connection according to the second embodiment. In this example, the ports P1 and Pan are erroneously connected. The erroneously connected cable is indicated by a line thicker than the other lines indicating the cables connecting the other ports in FIG. 17 (the erroneously connected cables will be indicated in the same way in the following drawings).

In this case, the CM 111 receives the slot number “0” of the SVC 121 and the port number “0” of the port Pa0 via the port P0. In addition, the CM 111 receives the slot number “0” of the SVC 121 and the port number “n” of the port Pan via the port P1.

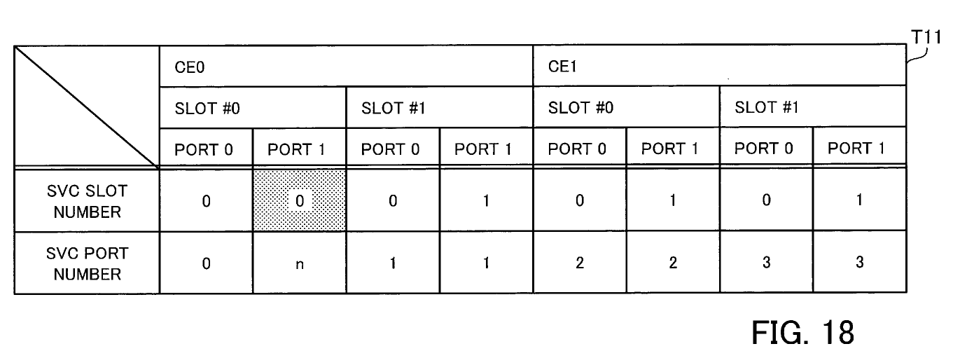

FIG. 18 illustrates example 1 of erroneous connection determination processing according to the second embodiment. A table T11 indicates a list of connection information acquired via the ports of the CMs 111, 112, 111a, and 112a from the SVCs 121 and 122 when the connection in FIG. 17 is established.

In the table T11, the CEs 110 and 110a are indicated as “CE0” and “CE1,” respectively, and the CM 111 is indicated as “slot #0” under “CE0.” In addition, the ports P0 and P1 of the CM 111 are indicated as “port 0” and “port 1,” respectively. The CM 112 is indicated as “slot #1” under “CE0.” In addition, the ports P2 and P3 of the CM 112 are indicated as “port 0” and “port 1,” respectively. In addition, the CM 111a is indicated as “slot #0” under “CE1.” In addition, the ports P4 and P5 of the CM 111a are indicated as “port 0” and “port 1,” respectively. In addition, the CM 112a is indicated as “slot #1” under “CE1.” In addition, the ports P6 and P7 of the CM 112a are indicated as “port 0” and “port 1,” respectively. These components will be indicated in the same way in the following drawings as needed.

As described above, in the example in FIG. 17, the port P1 receives the SVC slot number “0” and the SVC port number (connection destination port number) “n.” In this case, the port number “1” of the port P1 does not match the SVC slot number “0” (this mismatched number is shaded). Namely, this connection with the port P1 does not satisfy the connection condition (1). Thus, the CM 111 determines that the port P1 is erroneously connected.

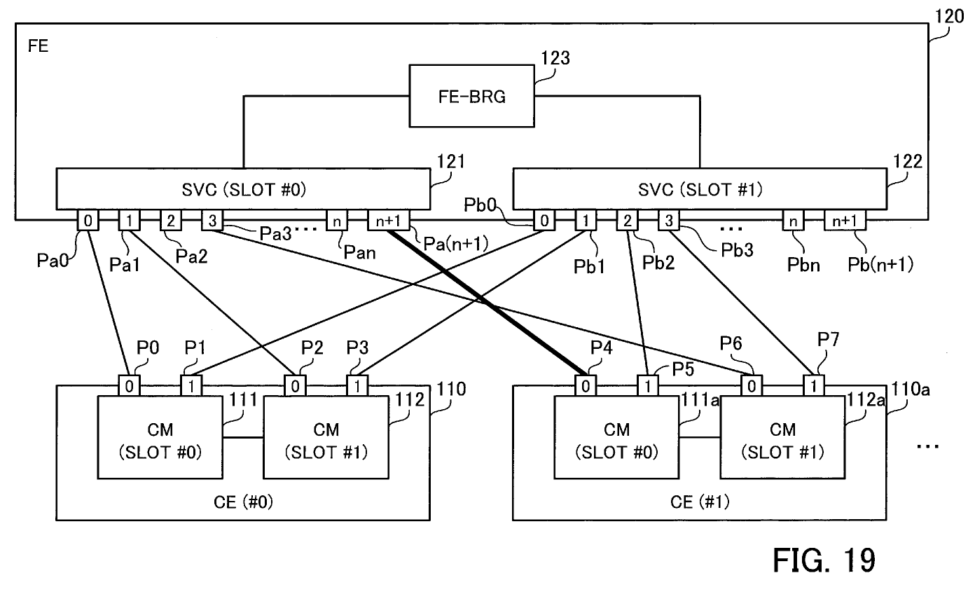

FIG. 19 illustrates example 2 of erroneous connection according to the second embodiment. In this example, the ports P4 and Pa(n+1) are erroneously connected. In this case, the CM 111a receives the slot number “0” of the SVC 121 and the port number “n+1” of the port Pa(n+1) via the port P4. In addition, the CM 111a receives the slot number “1” of the SVC 122 and the port number “2” of the port Pb2 via the port P5.

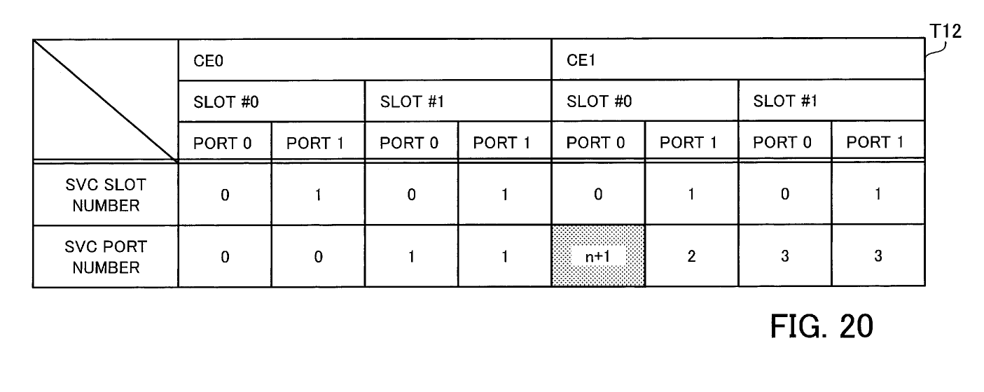

FIG. 20 illustrates example 2 of erroneous connection determination processing according to the second embodiment. A table T12 indicates a list of connection information acquired via the ports of the CMs 111, 112, 111a, and 112a from the SVCs 121 and 122 when the connection in FIG. 19 is established.

As described above, in the example in FIG. 19, the port P4 receives the SVC slot number “0” and the SVC port number (connection destination port number) “n+1.” In this case, the port number “0” of the port P4 matches the SVC slot number “0.” Thus, the CM 111a determines that this connection with the port P4 satisfies the connection condition (1).

Next, the CM 111a compares the slot number “0” of the CM 111a with the port number (connection destination port number) “n+1” of the port Pa(n+1), which is the connection destination port of the port P4. Since the CM 111a is located in an even number slot in the CE 110a and the connection destination port number of the port P4 is an odd number, the CM 111a determines that the both numbers do not match (both number are not even or odd numbers). Namely, the CM 111a determines that this connection with the port P4 does not satisfy the connection condition (2). Thus, the CM 111a determines that the port P4 is erroneously connected.

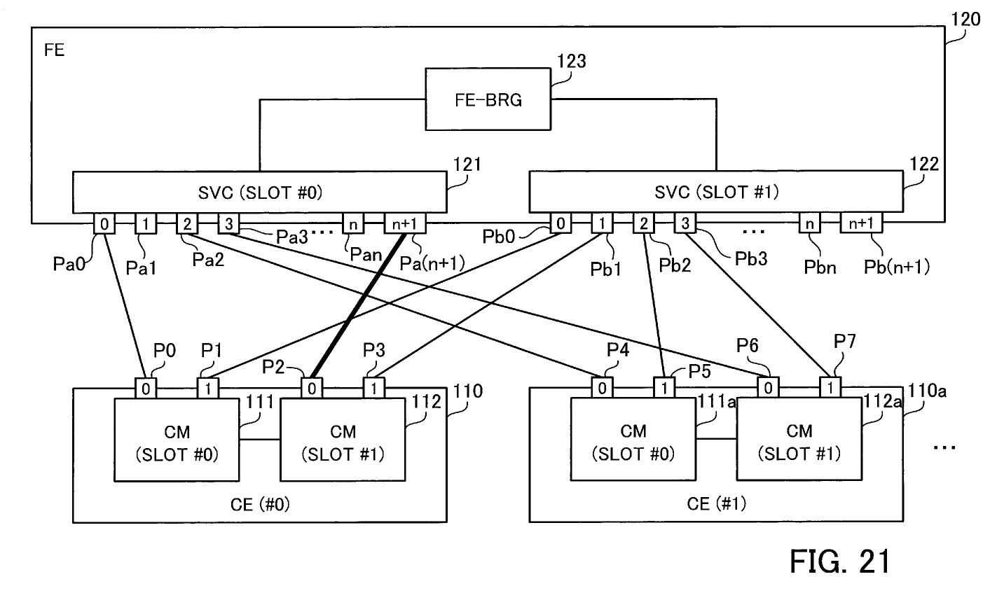

FIG. 21 illustrates example 3 of erroneous connection according to the second embodiment. In this example, the ports P2 and Pa(n+1) are erroneously connected. In this case, the CM 112 receives the slot number “0” of the SVC 121 and the port number “n+1” of the port Pa(n+1) via the port P2. In addition, the CM 112 receives the slot number “1” of the SVC 122 and the port number “1” of the port Pb1 via the port P3.

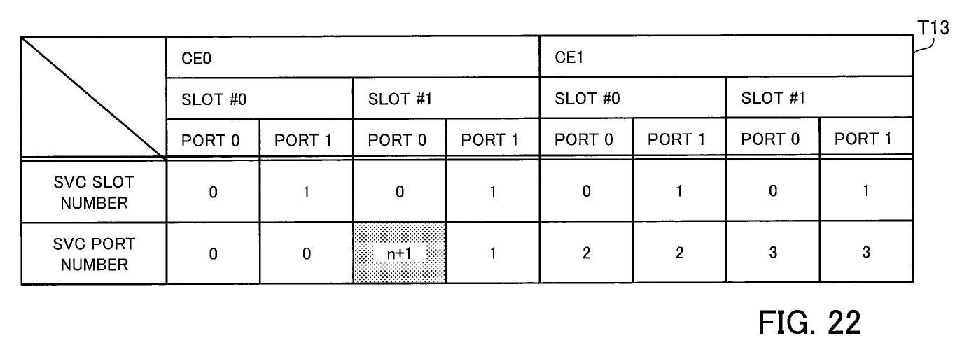

FIG. 22 illustrates example 3 of erroneous connection determination processing according to the second embodiment. A table T13 indicates a list of connection information acquired via the ports of the CMs 111, 112, 111a, and 112a from the SVCs 121 and 122 when the connection in FIG. 21 is established.

As described above, in the example in FIG. 21, the port P2 receives the SVC slot number “0” and the SVC port number (connection destination port number) “n+1.” In this case, the port number “0” of the port P2 matches the SVC slot number “0.” Thus, the CM 112 determines that this connection with the port P2 satisfies the connection condition (1).

Next, the CM 112 compares the slot number “1” of the CM 112 with the port number (connection destination port number) “n+1” of the port Pa (n+1), which is the connection destination port of the port P2. Since the CM 112 is located in an odd number slot in the CE 110 and the connection destination port number of the port P2 is an odd number, the CM 112 determines that the both numbers match (both number are odd numbers). Thus, the CM 112 determines that this connection with the port P2 satisfies the connection condition (2). The CM 112 determines that the connection with the port P3 also satisfies the connection conditions (1) and (2).

Next, the CM 112 compares the connection destination port number “n+1” of the port P2 with the connection destination port number “1” of the port P3 and determines that both numbers do not match. Thus, the CM 112 determines that the connections with the ports P2 and P3 do not satisfy the connection condition (3). However, at this point, the CM 112 has not yet determined which one of the ports P2 and P3 is erroneously connected.

Thus, the CM 112 acquires the result of the matching processing performed by the CM 111 from the CM 111. The CM 111 has already determined that the correct connection destination port number of the CM 111 is “0.” Thus, the connection destination port number of the CM 112 is expected to be a number next to the connection destination port number “0” of the CM 111. Namely, “1” is expected to be the connection destination port number of the CM 112. The CM 112 determines that, while the connection destination port number “1” of the port P3 matches the expected connection destination port number “1,” the connection destination port number “n+1” of the port P2 does not match the connection destination port number “1.” Namely, between the connections with the ports P2 and P3, only the connection with the port P2 does not satisfy the connection condition (4). Thus, the CM 112 determines that the port P2 is erroneously connected and the port P3 is correctly connected.

In this case, the CM 111 determines that the connection destination port number of the CM 111 is “0.” In contrast, the CM 112 has not yet determined its connection destination port number. Thus, the CM 111 determines that the connections with the ports P0 and P1 are correct.

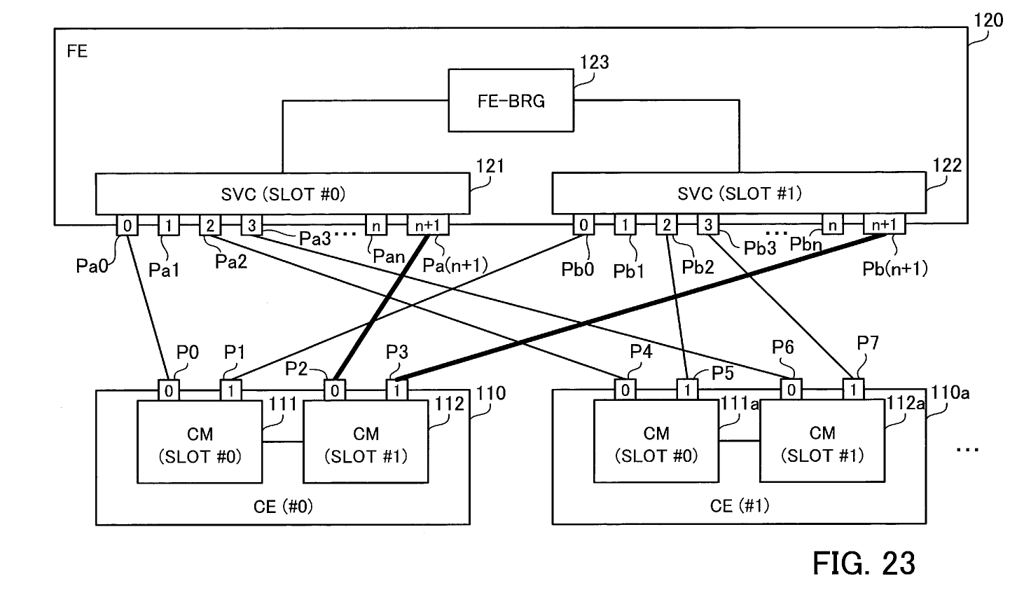

FIG. 23 illustrates example 4 of erroneous connection according to the second embodiment. In this example, the ports P2 and Pa(n+1) are erroneously connected, and the ports P3 and Pb(n+1) are erroneously connected. In this case, the CM 112 receives the slot number “0” of the SVC 121 and the port number “n+1” of the port Pa(n+1) via the port P2. In addition, the CM 112 receives the slot number “1” of the SVC 122 and the port number “n+1” of the port Pb(n+1) via the port P3.

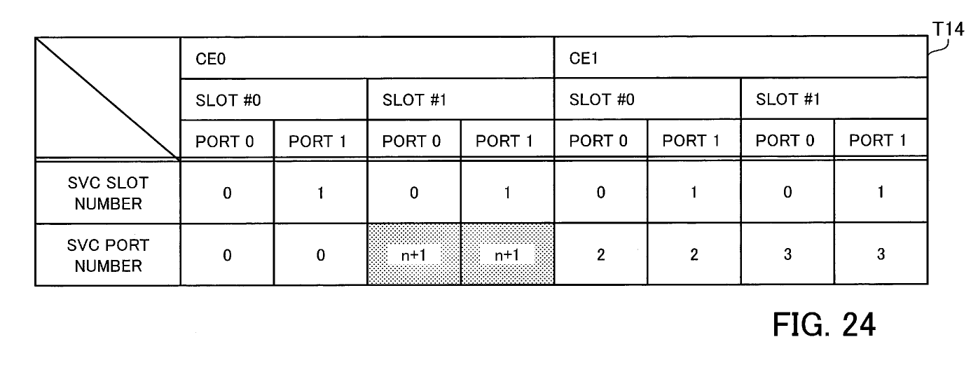

FIG. 24 illustrates example 4 of erroneous connection determination processing according to the second embodiment. A table T14 indicates a list of connection information acquired via the ports of the CMs 111, 112, 111a, and 112a from the SVCs 121 and 122 when the connection in FIG. 23 is established.

As described above, in the example in FIG. 23, the port P2 receives the SVC slot number “0” and the SVC port number (connection destination port number) “n+1.” In addition, the port P3 receives the SVC slot number “1” and the SVC port number (connection destination port number) “n+1.”

In this case, the port number “0” of the port P2 matches the SVC slot number “0.” Thus, the CM 112 determines that this connection with the port P2 satisfies the connection condition (1). In addition, the port number “1” of the port P3 matches the SVC slot number “1.” Thus, the CM 112 determines that this connection with the port P3 satisfies the connection condition (1).

Next, the CM 112 compares the slot number “1” of the CM 112 with the port number (connection destination port number) “n+1” of the port Pa(n+1), which is the connection destination port of the port P2. Since the CM 112 is located in an odd number slot in the CE 110 and the connection destination port number of the port P2 is an odd number, the CM 112 determines that the both numbers match (both number are odd numbers). Thus, the CM 112 determines that this connection with the port P2 satisfies the connection condition (2).

Likewise, the CM 112 compares the slot number “1” of the CM 112 with the port number (connection destination port number) “n+1” of the port Pb(n+1), which is the connection destination port of the port P3. Since the CM 112 is located in an odd number slot in the CE 110 and the connection destination port number of the port P3 is an odd number, the CM 112 determines that the both numbers match (both number are odd numbers). Thus, the CM 112 determines that this connection with the port P3 satisfies the connection condition (2).

Next, the CM 112 compares the connection destination port number “n+1” of the port P2 with the connection destination port number “n+1” of the port P3 and determines that both numbers match. Thus, the CM 112 determines that the connections with the ports P2 and P3 satisfy the connection condition (3).

Next, the CM 112 acquires the result of the matching processing performed by the CM 111 from the CM 111 and determines whether the ports P2 and P3 are erroneously connected. The CM 111 has already determined that the connection destination port number of the CM 111 is “0.” Thus, the connection destination port number of the CM 112 is expected to be a number next to the connection destination port number “0” of the CM 111. Namely, “1” is expected to be the connection destination port number of the CM 112.

Since the connection destination port number of the ports P2 and P3 is “n+1,” the CM 112 determines that this number “n+1” does not match the expected connection destination port number “1.” Namely, the connections with the ports P2 and P3 do not satisfy the connection condition (4). Thus, the CM 112 determines that the ports P2 and P3 are erroneously connected.

In this example, the CM 111 also determines whether the ports P0 and P1 are erroneously connected in view of the CM 112, in the same way as the CM 112. The CM 112 has already determined that the connection destination port of the CM 112 number is “n+1.” Thus, the connection destination port number of the CM 111 is expected to be a number next to the connection destination port number “n+1” of the CM 112. Namely, “n” is expected to be the connection destination port number of the CM 111.

Since the connection destination port number of the ports P0 and P1 is “0,” the CM 111 determines that this number “0” does not match the expected connection destination port number “n.” Namely, the ports P0 and P1 do not satisfy the connection condition (4). Thus, the CM 111 determines that the ports P0 and P1 are erroneously connected. Thus, in this case, all the ports P0 to P3 in the CE 110 are determined to be erroneously connected.

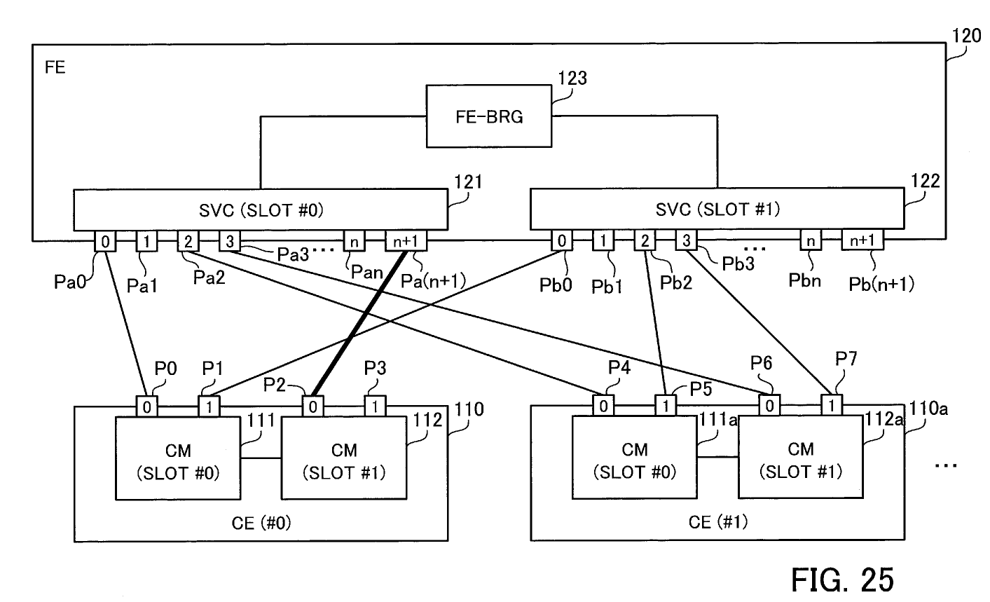

FIG. 25 illustrates example 5 of erroneous connection according to the second embodiment. In this example, the ports P2 and Pa(n+1) are erroneously connected, and the port P3 is not connected to any of the SVCs 121 and 122. In this case, the port P2 of the CM 112 receives the slot number “0” of the SVC 121 and the port number “n+1” of the port Pa(n+1). The port P3 of the CM 112 does not receive any connection information.

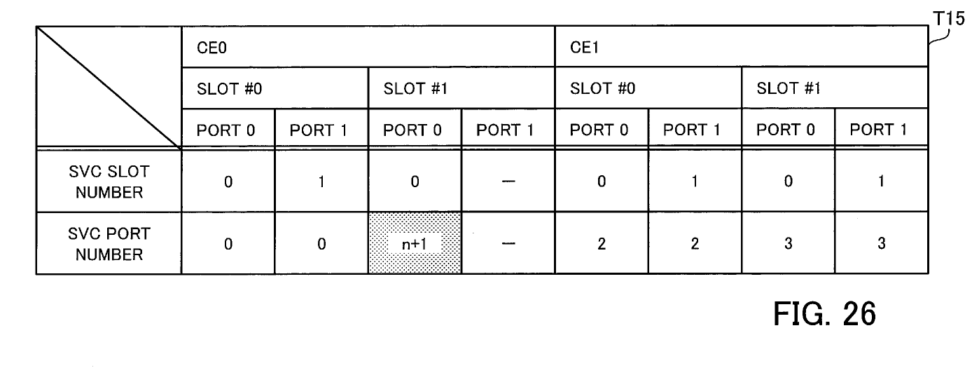

FIG. 26 illustrate example 5 of erroneous connection determination processing according to the second embodiment. A table T15 indicates a list of connection information acquired via the ports of the CMs 111, 112, 111a, and 112a from the SVCs 121 and 122 when the connection in FIG. 25 is established.

As described above, in the example in FIG. 25, the port P2 receives the SVC slot number “0” and the SVC port number (connection destination port number) “n+1.” In addition, the port P3 receives no SVC slot number “N/A” and no SVC port number (connection destination port number) “N/A.”

In this case, the port number “0” of the port P2 matches the SVC slot number “0.” Thus, the CM 112 determines that this connection with the port P2 satisfies the connection condition (1).

Next, the CM 112 compares the slot number “1” of the CM 112 with the port number (connection destination port number) “n+1” of the port Pa(n+1), which is the connection destination port of the port P2. Since the CM 112 is located in an odd number slot in the CE 110 and the connection destination port number of the port P2 is an odd number, the CM 112 determines that the both numbers match (both number are odd numbers). Thus, the CM 112 determines that this connection with the port P2 satisfies the connection condition (2).

Since the port P3 has not received any connection information, the CM 112 skips the matching processing based on the connection condition (3) on the ports P2 and P3. In this case, the CM 112 determines that the connection destination port number of the CM 112 to be “n+1,” which is the connection destination port number acquired by the port P2.

In addition, the CM 112 determines whether the port P2 is erroneously connected in view of the result of the matching processing obtained by the CM 111. The CM 111 has already determined that the connection destination port number of the CM 111 is “0.” In this case, the connection destination port number of the CM 112 is expected to be a number next to the connection destination port number “0” of the CM 111. Namely, “1” is expected to be the connection destination port number of the CM 112.

Since the connection destination port number of the port P2 is “n+1,” the CM 112 determines that this number “n+1” does not match the expected connection destination port number “1.” Namely, the connection with the port P2 does not satisfy the connection condition (4). As a result, the CM 112 determines that the port P2 is erroneously connected.

In this example, the CM 111 also acquires the result of the matching processing obtained by the CM 112 and determines whether the ports P0 and P1 are erroneously connected in view of the CM 112, in the same way as the CM 112. The CM 112 has already determined that the connection destination port number of the CM 112 is “n+1.” In this case, the connection destination port number of the CM 111 is expected to be a number next to the connection destination port number “n+1” of the CM 112. Namely, “n” is expected to be the connection destination port number of the CM 111.

Since the connection destination port number of the ports P0 and P1 is “0,” the CM 111 determines that this number “0” does not match the expected connection destination port number “n.” Namely, the connections with the ports P0 and P1 do not satisfy the connection condition (4). Thus, the CM 111 determines that the ports P0 and P1 are erroneously connected. Thus, in this case, all the ports P0 to P2 in the CE 110 are determined to be erroneously connected.

In this way, when an individual CM is connected to an individual SVC via a cable in the storage system 100, the individual CM determines whether its connection destination port is correct with respect to the connection destination port of a different CM on the basis of the result of the matching processing performed by the individual CM regarding its connection destination port number and the result of the matching processing performed by the different CM regarding the connection destination port number of the different CM in the same CE. As a result, the individual CM is able to appropriately detect whether it is accurately connected to the individual SVC via a cable.

As described in the second embodiment, other than connecting an individual SVC and individual CM via a cable, two SVCs and a plurality of CMs may be incorporated in a single CE. For example, SVCs and CMs may be inserted into slots of a back panel of a CE. In this case, an individual SVC may determine the ID of an individual CM on the basis of the corresponding slot ID of the back panel. However, according to this method, the number of CMs that can be installed is limited by the size (the number of slots) of the back panel. Thus, as in the second embodiment, for example, an individual CE may be arranged as a subsystem in which two CMs form a redundant configuration, and an individual FE may be arranged as a subsystem in which two SVCs form a redundant configuration. By connecting an FE and a plurality of CEs via cables, extensibility for CMs is improved.

However, in this case, there is still a problem about erroneous cable connections. If there is an erroneous connection between devices in the storage system 100, devices could be activated with the inconsistent connection. For example, in one conceivable method for checking erroneous connections, at the time of a factory acceptance test, correctly connected devices are activated, information about the serial numbers of the connected CMs is associated with port numbers of SVCs having a monitoring function, and the associated information is stored in the SVCs. In this case, when a CM is activated next time and a communication check between the CM and an SVC is performed, the SVC compares the serial number of the connection destination CM with the recorded serial number per port. If these numbers do not match, the SVC recognizes that the CM and the SVC are erroneously connected.

However, according to this method, if a device is erroneously connected and activated at the time of the factory acceptance test, the serial number of the erroneously connected CM is recorded in the SVCs. As a result, erroneous connections cannot appropriately be detected after devices are shipped. In addition, if an SVC is replaced by a service part (for example, a spare SVC) in a power-off state after shipment, the information about the serial number cannot be passed onto the new part. As a result, erroneous connections could not be detected. According to the method that uses such previously acquired information about the serial number of the connection destinations, the erroneous connection determination processing depends on the information. Namely, if the information is incorrect or lost, it could be difficult to perform an appropriate connection check. In addition, if the serial number of an individual CM is compared, an erroneous connection is detected per CM. Namely, erroneous connection cannot be detected per port.

In the storage system 100, whether a connection between each pair of ports via a cable between a CM and an SVC matches the connection conditions in the storage system 100 is determined, so as to determine whether an erroneous connection is made. In particular, in addition to the matching processing performed by each CM by using port numbers and slot numbers, CMs that belong to the same CE compare their connection destination port numbers with each other. Thus, erroneous connections between the CMs and the SVCs are appropriately detected. For example, even when one port of a certain CM (for example, the CM 112) is not connected to any SVC as illustrated in FIG. 25, an erroneous connection is detected in view of the result of the matching processing performed by a peer CM (for example, the CM 111).

The connection determination method according to the second embodiment is applicable, for example, to a different configuration in which each of the two units (two units that correspond to the CMs 111 and 112) that form a redundant configuration is connected to two connection destination devices.

The information processing according to the first embodiment may be realized by causing the control units 11b and 12b to execute a program. The information processing according to the second embodiment may be realized by causing the processor 171 to execute a program. The control device 11 may include a computer including the storage unit 11a (for example, a memory) and the control unit 11b (for example, a processor) (the same is true for the other control devices). In addition, the CM 111 may include a computer including the RAM 172 and the processor 171 (the same is true for the other CMs). The program may be recorded in the computer-readable recording medium 33.

For example, the program may be made available by distributing the recording medium 33 in which the program is recorded. The program may be previously stored in a different computer (for example, the operation server 200), and the stored program may be distributed via a network. For example, a computer may store (install) the program that is recorded in the recording medium 33 or received from the different computer in a storage device such as the MRAM 153 or the RAM 172, read the program from the storage device, and execute the program.

In one aspect, erroneous connections can appropriately be detected.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A control apparatus that is installable in plurality in a storage system and that controls data access to storage, the control apparatus comprising:
a plurality of first ports connectable to a plurality of connection destination ports of a connection destination apparatus via cables; and
a processor configured to perform a procedure including:
determining whether the control apparatus and the connection destination apparatus are correctly connected to each other, based on a result of first matching processing performed by using port numbers of the plurality of first ports and port numbers of the plurality of connection destination ports and a result of second matching processing performed by using port numbers of a plurality of second ports and the port numbers of the plurality of connection destination ports, the plurality of second ports being provided in a different control apparatus in a subsystem to which the control apparatus belongs.

2. The control apparatus according to claim 1,
wherein the result of the first matching processing includes a first port number of a first connection destination port connected to the control apparatus among the plurality of connection destination ports,
wherein the result of the second matching processing includes a second port number of a second connection destination port connected to the different control apparatus among the plurality of connection destination ports, and
wherein the determining includes determining whether the first port number is correct with respect to the second port number as a port number of a connection destination port connected to the control apparatus by comparing the first port number and the second port number.

3. The control apparatus according to claim 2,
wherein the determining includes determining that the first port number is correct as the port number of the connection destination port connected to the control apparatus when the first port number and the second port number are consecutive numbers, and
wherein the determining includes determining that the first port number is not correct as the port number of the connection destination port connected to the control apparatus when the first port number and the second port number are not consecutive numbers.

4. The control apparatus according to claim 2,
wherein the connection destination apparatus includes a plurality of connection units each including connection ports among the plurality of connection destination ports,
wherein the procedure further includes:
detecting whether the control apparatus is erroneously connected to the connection destination apparatus by comparing a port number of one of the plurality of first ports connected to one of the plurality of connection destination ports with a slot number of one of the plurality of connection units including the connection destination port, the slot number indicating an installation location of the connection unit in the connection destination apparatus; and
determining the first port number based on a port number of the connection destination port when no erroneous connection is detected.

5. The control apparatus according to claim 4,
wherein the detecting does not detect that the control apparatus and the connection destination apparatus are erroneously connected when the port number of the first port matches the slot number of the connection unit, and
wherein the detecting detectes that the control apparatus and the connection destination apparatus are erroneously connected when the port number of the first port does not match the slot number of the connection unit.

6. The control apparatus according to claim 2,
wherein the procedure further includes:
detecting whether the control apparatus and the connection destination apparatus are erroneously connected by comparing a slot number of the control apparatus with a port number of one of the plurality of connection destination ports connected to one of the plurality of first ports, the slot number indicating an installation location of the control apparatus in the subsystem; and
determining the first port number based on the port number of the connection destination port when no erroneous connection is detected.

7. The control apparatus according to claim 6,
wherein the detecting does not detect that the control apparatus and the connection destination apparatus are erroneously connected when both the slot number of the control apparatus and the port number of the connection destination port are even numbers or when both the slot number of the control apparatus and the port number of the connection destination port are odd numbers, and
wherein the detecting detects that the control apparatus and the connection destination apparatus are erroneously connected when one of the slot number of the control apparatus and the port number of the connection destination port is an even number and another of the slot number of the control apparatus and the port number of the connection destination port is an odd number.

8. The control apparatus according to claim 2,
wherein the procedure further includes determining the first port number by comparing port numbers of ones of the plurality of connection destination ports respectively connected to the plurality of first ports with each other.

9. The control apparatus according to claim 8,
wherein, when the connection destination ports respectively connected to the plurality of first ports have an identical port number, the determining determines the identical port number to be the first port number, and
wherein, when the connection destination ports have different port numbers, the determining determines each of the different port numbers of the connection destination ports to be the first port number to be compared with the second port number.

10. The control apparatus according to claim 1,
wherein the control apparatus is provided in plurality, and
wherein the subsystem is a system in which a redundant configuration is formed by the plurality of control apparatuses.

11. A storage system comprising:
a connection destination apparatus including a plurality of connection destination ports; and
a subsystem including a first control apparatus including a plurality of first ports connectable to the plurality of connection destination ports via cables, and a second control apparatus including a plurality of second ports connectable to the plurality of connection destination ports via cables,
wherein the first control apparatus determines whether the first control apparatus and the connection destination apparatus are correctly connected to each other, based on a result of first matching processing performed by using port numbers of the plurality of first ports and port numbers of the connection destination ports and a result of second matching processing performed by the second control appaartus using port numbers of the plurality of second ports and the port numbers of the plurality of connection destination ports.

12. A non-transitory computer-readable recording medium storing a computer program that causes a computer used in a control apparatus, which is installable in plurality in a storage system and controls data access to storage, to perform a procedure comprising:
determining whether the control apparatus, including a plurality of first ports connectable to a plurality of connection destination ports of a connection destination apparatus via cables, and the connection destination apparatus are correctly connected to each other, based on a result of first matching processing performed by using port numbers of the plurality of first ports and port numbers of the plurality of connection destination ports and a result of second matching processing performed by using port numbers of a plurality of second ports of a different control apparatus in a subsystem to which the control apparatus belongs and the port numbers of the plurality of connection destination ports.
